(19) United States
(12) Patent Application Publication
(10) Pub. No.: US 2006/0029184 A1
(43) Pub. Date: Feb. 9, 2006

(54) High-throughput methods for determining electron density distributions and structures of crystals

(75) Inventors: Dawei Lin, Athens, GA (US); Zhi-Jie Liu, Athens, GA (US); Jeremy Praissman, Athens, GA (US); John P. Rose, Winterville, GA (US); Wolfram Tempel, Toronto (CA); Bi-Cheng Wang, Athens, GA (US)

Correspondence Address: GREENLEE WINNER AND SULLIVAN P C, 4875 PEARL EAST CIRCLE, SUITE 200, BOULDER, CO, 80301, US

(73) Assignee: University of Georgia Research Foundation, Inc., Athens, GA (US)

(21) Appl. No.: 11/213,619

(22) Filed: Aug. 26, 2005

Related U.S. Application Data
(63) Continuation of application No. PCT/US04/05933, filed on Feb. 27, 2004.
(60) Provisional application No. 60/450,970, filed on Feb. 27, 2003.
(60) Provisional application No. 60/490,026, filed on Jul. 25, 2003.

(51) Int. Cl. G01N 23/207

(52) U.S. Cl. 378/73

(57) ABSTRACT

Disclosed are high-throughput methods for determining crystal structures from X-ray diffraction data, for example high-throughput crystal structure determination methods employing flexible, high-throughput modular computational pipelines, such as Bioperl computational pipelines. High-throughput methods for determining crystal structures can be fully or partially automated, and can be fully or partially computer executed. Crystal structure determination methods employing a pipeline interface, work flow manager and/or output parsers can be used to optimize the amount of structural information derived from an X-ray diffraction data set and increase the efficiency of calculating crystal structures from X-ray diffraction data.

### CROSS REFERENCE TO RELATED APPLICATIONS

This application is a continuation-in-part of International PCT Application No. PCT/US2004/005933, filed Feb. 27, 2004, which claims the benefit of U.S. Provisional Patent Application Nos. 60/450,970 and 60/490,026, filed Feb. 27, 2003 and Jul. 25, 2003, respectively, all of which are hereby incorporated by reference in their entireties.

### STATEMENT REGARDING FEDERALLY SPONSORED RESEARCH OR DEVELOPMENT

This invention was made, at least in part, with United States governmental support awarded by the National Institutes of Health Grant GM62407. The United States Government has certain rights in this invention.

### BACKGROUND OF INVENTION

Over the past fifty years, X-ray crystallography has emerged as a powerful technique for determining the structures of a wide variety of materials including complex molecules and molecular complexes. X-ray crystallographic methods presently constitute the most prolific tool for determining the structures of important biomolecules such as proteins, peptides, protein-protein complexes, carbohydrates, oligonucleotides and nucleic acid—protein complexes. Over 10,000 protein, peptide and nucleic acid structures have been obtained using X-ray crystallographic techniques. This structural information, along with a rapidly evolving body of complementary functional data, has contributed tremendously to our understanding of biology on the molecular level.

Electromagnetic radiation is used in diffractometric methods to resolve the structure of crystalline materials having interatomic distances comparable to the wavelength of the incident radiation. In single crystal X-ray crystallography techniques, for example, a substantially purified, single crystal sample of a molecule of interest is mounted between an X-ray source and an X-ray detector. An incident, monochromatic source beam of X-rays having a wavelength around 0.5 Å to about 2 Å is directed onto the crystal. Atoms positioned in various planes of the crystal diffract the source beam, thereby, generating a plurality of discrete, refracted X-ray beams. These diffracted X-ray beams, commonly referred to as reflections, are individually detected and characterized with respect to their spatial orientation and intensity distribution, thereby generating an X-ray diffraction pattern. To maximize the amount of available information relating to crystal structure, diffraction patterns are commonly collected for all unique orientations of a crystal by successive rotation during illumination. In addition, diffraction patterns are often collected at a plurality of different X-ray wavelengths to gain more insight into the structure of the crystal under examination. Essential to the collection of useful X-ray diffraction data, however, is the use of high quality, substantially pure crystalline samples characterized by a single phase having a well ordered crystalline structure.

Each reflection off a crystal can be characterized by three spatial indices, h, k, and l, which describe the reciprocal lattice used in interpreting diffraction data. In addition, each reflection off a crystal can be characterized by its intensity distribution l(h, k, l), which is also expressed in terms of the three spatial indices h, k and l. As the intensities and directions of diffracted X-ray beams are uniquely determined by the position of atomic scatterers in the irradiated crystal, analysis of X-ray diffraction patterns provides quantitative information related to the orientation of atoms and molecules in the crystalline lattice. A crystal is characterized as a three-dimensional translational structure of crystalline unit cells, which comprise the smallest and simplest volume element of a crystal that is representative of the structure of the whole crystal. In addition to its translational symmetry, a crystalline structure can be characterized by symmetries within its unit cell. In the case of a protein molecule, there are 72 known ways to combine the symmetry operations in a crystal, commonly referred to as space symmetry groups.

To resolve a crystalline structure, an electronic density distribution, ρ(u, v, w), of the crystal must be obtained from the measured reflection data. The electron density distribution, is a three-dimensional function of the coordinate system tied to the axes of the unit cell of the crystal, and is often graphically represented as an electron density map. Interpretation of an electron density distribution allows for development of a molecular model for the crystal. This iterative processes, commonly referred to as map fitting, largely consists of using interactive computer graphics to build a molecular model which practically fits within the molecular surface implied by the map. A given model is iteratively assessed and refined by evaluating the continuity of electron density between the putative crystal structure and the calculated electron density distribution, and by comparing the collected X-ray diffraction pattern with computer simulated diffraction patterns corresponding to putative crystal structures. To be a realistic description, the final model must be consistent with the diffraction data, and posses bond angles, bond lengths and atomic configurations that are consistent with the principles of molecular structure and stereochemistry of the relevant class of compounds. In the context of determining protein structures, supplementary information, such as protein amino acid sequence, peptide bond angles and known secondary and tertiary structure motifs, assists considerably in constraining the molecular model developed for a given crystal to a finite set of realistic solutions. Currently, automated high-throughput methods for determining the structure of biomolecules, such as proteins, peptides and oligonucleotides, are greatly needed to provide structural information complementary to the growing body of functional data related to the biological activity these compounds. Indeed, high-throughput methods of macromolecule structure determination would assist greatly in the discovery and development of small molecule pharmaceuticals capable of interacting with individual proteins, protein aggregates, carbohydrates, nucleic acids or other macromolecules important in regulating normal cell functioning and disease pathways.

X-ray diffraction patterns may be directly interpreted to calculate structure factors which comprise the summation of wave equations for all atomic scatterers in a defined volume element giving rise to each reflection. Structure factors alone are insufficient to determine the electron density distribution of a crystal of interest. The phase of each reflection, commonly expressed in terms of phase angle, is also required to arrive at an accurate electron density distribution. This essential phase information, however, cannot be determined by simply collecting and analyzing X-ray diffraction patterns. Rather, estimates of the phases of reflections must be ascertained using either the structure of a related compound or inferred from attributes of the diffraction data itself or diffraction data of derivative crystals, such as heavy atom derivatives.

A number of analytical methods have evolved over the last several decades which provide accurate means of estimating the phase angles generated upon illumination of crystals comprising large molecules (molecular mass >500 Da). The most common methods of resolving the crystal structures of high molecular mass compounds are: (1) isomorphous replacement (MIR, SIR) methods, (2) molecular replacement (MR) methods and (3) anomalous scattering (MAD, SAS) techniques. Although these methods provide a means of solving the phase problem, the phase estimates provided are often limited to an incomplete set of reflections. Therefore, subsequent improvement, refinement and probability weighting of the phase estimates are often necessary to arrive at electron density distributions, which can be used to interpret a sample's structure. Techniques for collecting and interpreting X-ray diffraction data obtained from large molecules, such as complex biomolecules, are described in “Principles of protein X-ray crystallography” by Jan Drenth, Springer-Verlag, 2000, “The Basics of Crystallography and Diffraction” by Christopher Hammond, Oxford University Press, 2001 and “Crystal Structure Analysis for Chemists and Biologist” by J. P. Glusker, M. Lewis and M. Rossi, VCH Publishers, Inc., 1994, all of which are hereby incorporated by reference to the extent not inconsistent with the present disclosure.

In isomorphous replacement, the diffraction pattern of a native crystalline sample is collected and compared to the diffraction pattern of a derivative of the crystal, typically a heavy atom derivative. For example, heavy atoms, such as ions or complexes of Hg, Pt, Au, may be incorporated into a crystal in chemically specific and reproducible spatial orientations. To be most effective, the derivative crystals should be isomorphic with the native crystal, such that incorporation of the additional atoms does not significantly affect the lattice structure of the crystal sample. Diffraction patterns corresponding to native crystal and derivative crystal are compared to identify differences which may be used to calculate estimates of the phases of the observed reflections. In this method, perturbations caused by the introduction of heavy atoms into the derived structure provide a basis for estimating phase information. For example, differences between the amplitude of structure factors calculated for reflections for the native crystal and heavy-atom derivative may be used to generate a modified diffraction pattern corresponding to scattering by heavy-atom scatterers alone. Interpretation of this modified diffraction pattern provides a means of deriving phase estimates for the native crystal. These estimates are very crucial to the eventual success of the structure determination by iterative phase improvement. An inaccurate estimation at this stage often is responsible for inability for arriving at the correct structure.

In molecular replacement methods calculated phases from the structure factors of a reference protein are used as initial estimates of the phases of a target protein of interest. For example, a structurally related reference protein, such as a homolog, often provides a useful phasing model for deriving an electron density distribution of a target protein of interest. An advantage of this phase estimation technique is that is makes use of ever expanding databases of protein and peptide structures. Molecular replacement methods have been successfully applied using isomorphous reference crystals wherein the model phases may be used directly as estimates of the phases of reflections corresponding to the target molecule. Molecular replacement methods may also employ nonisomophous reference crystal structures to determine initial phase estimates. In this case, however, the reference protein must be properly superimposed upon the target protein to arrive at the best phasing model, which commonly requires an iterative refinement process involving successive alignment of the reference protein via rotation and translation.

Anomalous scattering techniques take advantage of the capacity of heavy atoms, such as S, Se, P, Cl or metals, to absorb X-ray radiation, in addition to scattering X-rays. Absorption of X-rays by a heavy atom followed by re-emission of light with an altered phase results in Bragg reflections related by inversion through the origin, referred to as Friedel pairs, which are not equal in intensity. Measurements of the differences in intensities of members of Friedel pairs provide a means for estimating the phases of these reflections. Typically, the intensity differences between members of a Friedel pair are very small, often less than 5%. Therefore, the ability to arrive at accurate structures using anomalous dispersion techniques is highly dependent on collecting X-ray diffraction data having signal-to-noise ratios sufficiently large to allow the difference in intensity between members of Friedel pairs to be accurately measured. A decade ago it was believed that the accuracy of structures determined using anomalous dispersion techniques can be greatly increased by collecting and analyzing diffractions patterns corresponding to a plurality of different incident X-ray wavelengths using multiple wavelength anomalous diffraction (MAD) methods. Although it is still the practice of many crystallographers, this thinking is no longer the only way for improving the final phases, as the crystals are often be damaged by X-ray radiation and unable a set of complete data to be collected at anther incident X-ray wavelength.

Although molecular replacement, anomalous scattering and isomorphous replacement techniques provide valuable means of determining phase information essential to structure calculations involving high molecular weight molecules, current applications of these techniques involves extensive iterative successive phase refinement. These iterative processes often involve a repeated sequence of steps which successively improves the accuracy of the electron density distribution determined from an X-ray diffraction data set. For example, an estimated electron density distribution may be first calculated using initial phase estimates and observed X-ray diffraction data. Second, the estimated electron density distribution may be evaluated to identify any apparent molecular features, such as the molecule-solvent phase boundary or specific groups of atoms, and refined to more accurately reflect the electron density corresponding to those features identified. Next, the refined electron density distribution or partial atomic model identified may be used to calculate new structure factors and estimated phases of reflections. Similar to this process of arriving at a reliable electron density distribution, iterative refinement also plays a major role in developing a molecular model from a calculated electron density distribution. In both applications, iterative refinement processes provide a practical means of converging a solution to a value which reflects an electron density distribution and crystal structure which best represents the crystal under investigation.

While iterative refinement provides an extremely valuable tool in MR, MIR, SIR, MAD and AS techniques, if initial estimates of the phase of observed reflections are not close enough to the correct phase angles, successive refinement may result in convergence to a local minimum corresponding to a structure, which does not truly reflect the actual structure of the crystal. Further, selection of inappropriate phase estimates may lead to solutions which do not converge at all, by continually becoming larger or oscillating between several values.

It will be appreciated from the foregoing that there is a need in the art for flexible, high-throughput methods of determining accurate initial phases (or initial electron density distribution), prior to the iterative refinement process. In the conventional crystallographic techniques, no systematic approaches have been applied to automatically generate many sets of possible initial phases. In particular, methods of determining initial phases (or electron density distributions) and crystal structures from X-Ray diffraction data which are capable of full or partial automation are greatly needed. Additionally, methods of determining accurate initial phases (or electron density distributions) and crystal structures from X-ray diffraction data are needed which screen a larger input parameter space than is practically screened by conventional manual iterative refinement methods and are not susceptible to operator-introduced bias. Furthermore, methods of determining electron density distributions and crystal structures from X-ray diffraction data are needed that are less susceptible to problems involving solution convergence to local minima.

### SUMMARY OF THE INVENTION

The present invention relates to methods of diffractometrically determining electron density distributions and structures of crystals. The present methods are particularly well suited for determining electron density distributions and structures of complex materials such as crystals comprising large molecules (molecular mass >500 Da), including but not limited to, proteins, peptides, protein-protein complexes; peptide-peptide complexes; protein-lipid complexes; oligonucleotides; carbohydrates; lipid-carbohydrate complexes, protein-peptide complexes; protein-cofactor complexes; and nucleic acid - protein complexes. It is an object of the present invention to provide high-throughput computational methods for determining initial phase estimates of diffracted X-ray beams, electron density distributions, crystal structures from X-ray diffraction data which are capable of full or partial automation. It is another object of the present invention to provide flexible computational methods employing modular, computational pipelines capable performing a wide range of crystallographic and bioinformatics calculations, and also capable of determining electron density distributions and crystal structures for a wide range of compounds and crystal types. It is a further goal of the present invention to integrate bioinformatics computational tools into crystallographic analysis methods to provide high-throughput structure determination methods capable of screening a larger input parameter space than screened in conventional crystallography techniques, and exhibiting improved accuracies and success rates over conventional crystallography techniques. It is another goal of the present invention, to provide high-throughput methods for determining crystal structures which require substantially less operator oversight than conventional crystallography techniques.

In one aspect, the present invention provides high-throughput methods for determining crystal structures which efficiently screen a wide input parameter space by carrying out a plurality of crystal structure calculations corresponding to a wide range of combinations of variable and fixed input parameters. An exemplary embodiment of this aspect of the present invention involves providing an X-ray diffraction data set and a set of input parameters. X-diffraction data sets useful in this aspect of present invention comprise a plurality of intensities and positions (or directions) of X-ray beams diffracted from a crystal. X-ray diffraction data sets may comprise diffraction data corresponding to a single X-ray wavelength or a plurality of X-ray wavelengths, and may comprise X-ray diffraction data corresponding to a plurality of crystal orientations. Exemplary input parameters include one or more variable input parameters and one or more fixed input parameters. Each variable input parameter has a plurality of screened values ranging from a lower limit to an upper limit and each fixed input parameter has a fixed value. All possible combinations of the screened values for each of the variable input parameters and the fixed values for each fixed input parameter are determined, and used to initialize a plurality of crystal structure calculations corresponding to each combination of screened and fixed values. In an exemplary embodiment, each combination of screened and fixed values comprises all of the fixed values and one screened value for each variable input parameter. Putative crystal structures corresponding to each of the combinations are calculated, preferably via independent, parallel structure calculations for each combination of variable and fixed input parameters. The confidence of each putative crystal structure is assessed and a confidence assessment is assigned to each of the putative crystal structures. The structure of the crystal is determined by selection of the putative crystal structure having the highest confidence assessment. High-throughput crystal structure determination methods of the present invention may be entirely computer executed or may be partially computer executed.

Crystal structure calculations and confidence assessments corresponding to a wide range of combinations of variable and fixed input parameters provide an effective means of searching a selected parameter space to identify the best crystal structure for a given sample. In crystallographic calculations, input parameters provide a means of constraining a crystal structure solution to a finite, realistic set of possible solutions. The effect of such computational constraints is to facilitate solution convergence to putative crystal structures which accurately reflect a crystal's structure. In addition, such computational constraints are useful for optimizing efficient expenditure of computational resources used during crystal structure calculations, such as processor time. Furthermore, input parameters provide necessary starting points for estimating phase angles corresponding to diffracted X-ray beams, determining electron density distributions and iteratively refining calculated crystal structures. As most realistic crystal structure calculations do not have an exact analytical solution, use of a wide range of combinations of variable and fixed input parameters improves the likelihood that an accurate structure will be obtained. Evaluation of a wide parameter space in the present invention also provides methods of identifying a crystal structure solution corresponding to a global minimum within a selected parameter space. In this context, a solution corresponding to a global minimum represents a crystal structure that best fits the X-ray diffraction data and also accords with any additional supplementary structure related information, such as the peptide sequence or composition and/or known bond angles, bond lengths and atomic configurations for a given compound or class of compounds. Methods of the present invention for efficiently screening a wide input parameter space are less susceptible than convention crystallographic methods to problems associated with convergence to structure solutions representing local minima in a given input parameter space.

In an exemplary embodiment, the methods of the present invention are particularly well suited for screening a selected parameter space for determining initial phase estimates for diffracted X-ray beams in an X-ray diffraction data set. Accurate determination of initial phase estimates by the present invention allows for the calculation of realistic electron density distributions for crystals, which may be used to determine crystal structures. As the phase angles of diffracted X-ray beams cannot be directly analytically determined for most crystals comprising large molecular weight compounds, the methods of the present invention utilize a series of parallel calculations reflecting a wide range of fixed and variable input parameters to determine estimates of these phases. Parallel calculations performed in the present invention may use any method of determining initial phase estimates known in the art including, but not limited to, single-wavelength anomalous diffraction methods, multiple-wavelength anomalous diffraction methods, molecular replacement methods, single isomorphous replacement methods, multiple isomorphous replacement methods or any combination of these.

Variable input parameters of the present invention may be characterized in terms of an upper limit, a lower limit and a means for determining screened values between upper and lower limits. For example, the set of screened values for a given variable input parameter may comprises a plurality of values that systematically vary by selected screening increment from a selected lower limit to a selected upper limit. The present invention includes embodiments using sets of screened values which vary by a constant screening increment and embodiments using sets of screened values which vary by a variable screening increment. Selection of the magnitude and functionality of a screening increment corresponding to a selected variable input parameter establishes the resolution of the screen of the selected parameter space achieved in a given crystal structure determination. Exemplary variable input parameters which may be screened in the present invention include, but are not limited to, the maximum resolution of the X-ray diffraction data, the minimum resolution of the X-ray diffraction data, the number of heavy atom scatterers in a unit cell of the crystal, the solvent content of the crystal, the number of molecules in an asymmetric unit of the crystal; the F″ of the X-ray diffraction data set (a measure of the strength of anomalous scattering); and the symmetry space group of the crystal. Exemplary fixed input parameters of the present invention include, but are not limited to, the wavelength(s) of the incident X-ray beam, the composition of the crystal, the sequence of a protein or oligonucleotide, crystal orientation(s) employed during exposure to X-rays, and program control parameters and/or switches in the program.

Crystal structure determination methods of the present invention search a considerably wider parameter space than may be practically searched using conventional, manual submission crystallographic methods. In an exemplary embodiment, crystal structure calculations and confidence assessments of structures are executed via parallel, independent crystal structure calculations. This aspect of the present invention provides an efficient means of screening a wide parameter space for a crystal structure that best represents the structure of the crystal under examination. In the context of the present invention, crystal structure determination via parallel, independent crystal structure calculations refers to methods wherein a plurality of calculations, portions of calculations or functional steps in calculations corresponding to different combinations of variable and fixed input parameter values are initiated separately and performed independently. In some embodiments useful for high-throughput analysis of X-ray diffraction data, at least some crystal structure calculations performed in parallel are carried out simultaneously or carried out in a manner overlapping in time. Crystal structure calculations performed in parallel may be divided among multiple processors using multiprocessing techniques, multiprogramming techniques and symmetric multiprocessing techniques. In exemplary embodiments of the present invention using a computing cluster, grid computing cluster or multiprocesser work station or computer, at least some crystal structure calculations performed in parallel may be assigned to different processors or submitted to different nodes in a computer network. An advantage of use of parallel crystal structure calculations in the methods of the present invention is that a calculations representing a very wide range of fixed and variable input parameter values may be initiated and executed nearly simultaneously, resulting in an efficient and comprehensive search of a wide parameter space. Additionally, methods of the present invention using parallel crystal structure calculations provide accurate crystal structures much more quickly than in conventional, manual submission crystallography techniques.

In another aspect, the present invention provides high-throughput methods for determining crystal structures which employ one or more computational pipelines for executing a plurality of structure calculations corresponding to various combinations of fixed and variable input parameters. Use of the term “computational pipeline” in the present invention refers to a series of functional units or functional stages, which perform selected computational tasks, such as calculating an electron density distribution or crystal structure, in several discrete steps. Exemplary computational pipelines comprise a series of commands or operations. In this aspect of the present invention, combinations of input parameters, particularly screened parameters, are provided as input to one or more computational pipelines which execute a plurality of independent crystal structure calculations. In an exemplary embodiment, a plurality of pipeline calculations corresponding different combinations of variable and fixed input parameters are executed in parallel, for example running parallel on a computing cluster.

Computational pipelines of the present invention are capable of efficiently carrying out variety of X-ray diffraction calculations including, but not limited to, single-wavelength and multiple-wavelength anomalous diffraction calculations, molecular replacement calculations, single isomorphous replacement calculations and multiple isomorphous replacement calculations. In addition, computation pipelines of the present invention may also be capable of refining and validating calculated crystal structures. In an exemplary embodiment, each functional unit in the pipeline is provided with input which may be input parameters provided by a user or pipeline interface or may comprise the output of another functional unit in the computational pipeline. Operation of a given pipeline analysis module generates an output corresponding to a specified, functional task, which may comprise input to another analysis module or the output of the pipeline itself. Optionally, analysis modules may be linked together in modular computational pipelines of the present invention using reformatting programs, such as input wrappers, output wrappers and/or run wrappers. In these embodiments, compatibility between analysis modules is achieved using the appropriate data wrappers to pass data between different analysis modules in the pipeline. The present invention also includes methods wherein a plurality of different computational pipelines are constructed and used to determine a crystal structure.

Computational pipelines useful in some applications of the present invention are built upon Bioperl-pipeline (Stajich J E, Block D, Boulez K, Brenner S E, Chervitz S A, Dagdigian C, Fuellen G, Gilbert J G R, Korf I, Lapp H, Lehvaslaiho H, Matsalla C, Mungall C J, Osborne B I, Pocock M R, Schattner P, Senger M, Stein L D, Stupka E D, Wilkinson M, Birney E. The Bioperl Toolkit: Perl modules for the life sciences. Genome Research. 2002 Oct.;12(10):1161-8). Specific information relating to the Bioperl-pipeline may be found on the related internet website maintained by The Bioperl Project. Use of a bioperl-pipeline provides substantial versatility because once the pipeline infrastructure is completed, a diverse range of the modules and capabilities, such as sequence comparison and alignment program modules, error analysis and confidence assessment modules, format converting modules, biological database access modules, annotation modules, and data mining modules, can be easily integrated into the pipeline. Computational pipelines of the present invention are highly compatible with bioperl modules and in an exemplary embodiment such bioperl modules may be integrated by adding text lines to a control XML file.

Different computational pipelines are characterized by different assemblies of analysis modules. The selection of particular sets of analysis modules in a computational pipeline is largely based on the particular application to be performed. Within a chosen pipeline, analysis modules are selected based on the objectives to be achieved, data quality, features unique to the crystallographic experiment and available computational resources. Individual analysis modules comprising modular computational pipelines of the present invention perform selected functional tasks. In one embodiment, the identities of individual analysis modules and the manner of linking different analysis modules to generate a desired computational pipeline is provided directly by a user or pipeline interface. Alternatively, the present invention comprises embodiments wherein the identities of individual analysis modules and the manner of linking different analysis modules to generate the pipeline are predetermined. Analysis modules of the present invention include, but are not limited to, analysis modules capable of calculating the phases of diffracted X-ray beams, determining electron density distributions and crystal structures, evaluating uncertainties or errors in computational steps in a crystal structure calculation, searching peptide sequence databases and structural databases for reference structures useful in molecular replacement calculations, aligning reference structures onto calculated electron density distributions, calculating signal-to-noise ratios of X-ray diffraction data, calculating structure factors, calculating Patterson functions, evaluating the strength of anomalous scattering in X-ray diffraction data, extracting phase information from anomalous scattering data, evaluating the agreement between an observed X-ray diffraction pattern and a calculated X-ray diffraction pattern corresponding to a putative crystal structure, refining calculated crystal structures and verifying calculated electron density distributions and crystal structures. Although pipeline calculations corresponding to different combinations of variable and fixed input parameters are typically run in parallel, calculations between different analysis modules for a given combination are often calculated serially, because one analysis module 's input may comprise the output of a previous analysis module in the pipeline. Computational pipelines of the present invention may also comprise error checking, error correcting and/or error flagging analysis modules which are capable identifying computational problems encountered during a calculation of putative crystal structures, such as a calculation which fails to converge. In the event of identifying such an computational problem, the module may: (1) initiate the shut down of the putative peptide structure calculation experiencing a problem, (2) remedy the problem by providing additional information to the pipeline or (3) reinitialize and re-execute the calculation.

In another aspect, the present methods provide high-throughput methods of determining crystal structures employing a flexible pipeline interface. In one embodiment the pipeline interface provides a means of authenticating pipeline usage, collecting and organizing data and input parameters and initiating job tracking and monitoring. Data collected by the pipeline interface may include X-ray diffraction data comprising intensities, positions and/or directions of diffracted X-ray beams, sequence information related to polymers such as proteins, peptides, oligonucleotides or carbohydrates or molecular complexes of these and a structural coordinate file of a selected search model which describes the best orientation of a reference molecule with respect to the orientation of a crystal under examination. In one embodiment, the pipeline interface allows the user to specify input parameter combinations which are screened in a given computation. Alternatively, the interface itself may provide screened input parameter combinations as a default setting. The pipeline interface may also provide a means of collecting pipeline module identifiers, which identify the type of calculations to be carried out, the type of crystal structure analysis method to be employed, the identities of modules comprising a selected computational pipeline or the identity of the desired computational pipeline itself. This information is useful for generating the computational pipeline required to achieve a selected computational task. The pipeline interface may also be capable of providing a user with one or more default values or parameter ranges corresponding to variable input parameters and/or fixed input parameters required for a given structure calculation.

In an exemplary embodiment, the pipeline interface gathers information through the use of internet web-based forms or XML control files. Using the XML control line, directories, file names, program options, file locations, number of computer notes (in the case of using a computer cluster), locations of temporary disk space and output locations can be easily specified. Once such a command file is constructed, repeated operation can be run without further interaction with the internet website, or modification can be made based on previously established scripts.

In an exemplary embodiment, a pipeline interface also provides a means of verifying the X-ray diffraction data, variable input parameters and fixed input parameters provided by a user. Verification provided by the pipeline interface may include the step of verifying that all information required to complete a desired electron density distribution and/or crystal structure calculation has been collected. In addition, verification provided by the pipeline interface may include the step of verifying that the upper limits, lower limits and screening increments of variable input parameters, values of fixed input parameters and/or X-ray diffraction data are within a set of predefined ranges of values. Verification provided by user interfaces of the present invention ensures that computational resources are efficiently used and avoids examining parameter space not relevant to a given electron density distribution and/or structure calculation. Verification provided by pipeline interfaces of the present invention may also be used to identify user introduced errors in specifying input parameters and/or X-ray diffraction data.

In another embodiment, pipeline interfaces of the present invention generate as output one or more configuration files comprising a set of input parameters and X-ray diffraction data necessary to initiate selected crystal structure calculations. Configuration files generated by pipeline interfaces of the present invention may comprise input to another algorithm or computer program, such as a work flow manager, which is capable initializing and executing selected crystal structure calculations. Configurations files provided by the pipeline interface may optionally comprise all possible combinations of screened values corresponding to variable input parameter and fixed values corresponding to fixed input parameters. Configuration files useful in the present invention may be in any format and include XML files, tab or comma delimited flat files, free format text files.

Pipeline interfaces that are dictionary-driven are preferred for some aspects of the present invention. A dictionary-driven pipeline interface is built from a “dictionary” comprising a relational database that has been compiled in code. Dictionaries useful for dictionary driven pipeline interfaces of the present invention may be in the form of a text file or a database table. Dictionaries useful in pipeline interfaces of the present invention set forth and organize important information for executing a give electron density distribution and/or structure determination, such as the identities of fixed and variable input parameters, ranges of screened and fixed values, default values for fixed and screened values, the identities of analysis modules in a computational pipeline, supplemental crystal structure and/or composition information and the like. In one embodiment of the present invention, users initiate information gathering by providing a request comprising key words which identify a desired computational task to be undertaken and/or indicate what X-ray diffraction data is available for a crystal structure analysis. The user request is used in combination with the dictionary to generate a pipeline interface that facilitates collection and organization of information needed from the user to perform a desired structure determination. For example, words in the user supplied request may be linked by the dictionary to program names or ID numbers, data file names, data locations, data directories, and other essential and optional components for the intended computation. Since user requests may indicate different combinations of input information and different structure calculation methods, this aspect of the present invention may be used to build a different pipeline to satisfy a unique computation based on this “dictionary-driven” programming approach.

One goal in using a dictionary-driven user interface is to separate the user interface process from the actual contents of the required input for various programs. In one aspect, the user interface defines the manner in which the information requested from the user is presented (e.g. through a text box, pull down menu or other graphical representation). Information presentation may be regarded as different from the content of the information presented and/or solicited. In an exemplary method, the manner in which the interface is presented to users as an input form is automated by specifying the contents of an input form in a dictionary comprising a collection of sufficient specifications to generate input forms. Exemplary specifications correspond to what information is needed to execute a selected crystal structure or electron density distribution calculation, the manner in which a user will provide the information, and the means of validating information input buy a user. An advantage of separating interface generation or presentation processes from the contents of input form is that this method provides the flexibility to quickly generate input forms for a large number of programs, computational pipelines and/or functional tasks. To add and change a pipeline, for example, only the dictionary needs to be modified and, therefore, no expensive programming is needed. Use of a dictionary-driven interface is also beneficial for maintaining software code embodying the present methods because such maintenance only requires editing the text contents of dictionary. An additional advantage is that this dictionary-driven technique allows other technologies, such as Java, to implement the user interface while preserving the information content of the dictionary.

An advantage of the dictionary-driven pipeline interface of the present invention is that it operates as a translator which ensures that the various input and output data formats of different crystallographic and bioinformatics analysis modules are compatible with each other. In addition, use of a dictionary-driven interface architecture provides the user substantial flexibility to add or improve backend pipeline analysis modules without interrupting the usage of the pipelines. Further, after a dictionary is constructed, a program can be written in a generic way to automatically generate an internet web-based form. The strength of this approach is that if a change is needed in the functionality of the program system, only the dictionary needs to be modified. This makes adding, updating and removing software tools extremely easy, since a new interface will be generated automatically. Preferred dictionary-driven pipeline interfaces are versatile internet web-based interfaces which are independent of the user operating system and do not require the user to set up the running environment on his machine.

In another aspect, the present methods provide high-throughput methods of determining crystal structures employing a workflow manager. Workflow managers of the present invention establish the interconnectivity of a plurality of object-oriented crystallographic and bioinformatics analysis modules comprising a desired computational pipeline. Preferred workflow managers useable in the present invention are capable of connecting a wide variety of analysis modules in many different workflow configurations to achieve a wide range of crystal structure calculations. In an exemplary embodiment, work flow managers are capable of receiving one or more configuration files from a pipeline interface which define how crystallographic software tools, bioinformatics software tools and computational algorithms interact with each other, and are capable of building computational pipelines corresponding to desired analysis module configurations.

In another embodiment, exemplary workflow managers of the present invention provide a means of executing a constructed computational pipeline by submitting appropriate data sets, input parameters and operation commands corresponding to a given structure calculation to a work station, such as a high-throughput computing cluster, Linux cluster, grid computing cluster, and/or multiprocessor computer. Further, exemplary workflow managers may provide a means of monitoring and controlling a given series of computational tasks to ensure that analysis modules are run in proper sequence and to ensure computing resources are used as efficiently as possible. Workflow managers of the present invention include, but are not limited to, Bioperl-pipeline based workflow managers.

Work flow managers of the present invention may also be capable of determining all possible combinations of screened values corresponding to variable input parameters and fixed values corresponding to fixed input parameters. In an exemplary embodiment, each combination of screened and fixed values determined by the work flow manager comprises all of the fixed values and one screened value for each variable input parameter. In this aspect of the present invention, the work flow manager determines the initialization parameters necessary for initializing and executing crystal structure calculations corresponding to all combinations of variable and fixed input parameters.

In another aspect, the present methods provide high-throughput methods of determining crystal structures employing one or more output parsers specific to various analysis modules or computational pipelines. Output parsers allow rapid analysis and/or visualization of the output of a computational pipeline and/or the various outputs of analysis modules comprising a computational pipeline. Output parsers of the present invention may provide a means of parsing out key data items useful to crystallographers and bioinformatitions in evaluating and refining electron density distributions and molecular models determined by the present methods. In a preferred embodiment, output parsing tools also provide links to the original data files and input parameters to facilitate the evaluation of electron density distributions and molecular models for structure validation. Output parsers useful in the present invention may comprise algorithms, subroutines or computer software applications which are in operational communication with a database comprising the output of discrete, analysis modules and/or computational pipelines.

An advantage of the modular architecture provided by the present invention is that a wide variety of different computational pipelines may be efficiently constructed to reflect a useful range of input parameters, bioinformatics and crystallographic computational tools and X-ray diffraction data types. This approach provides fully or partially automated methods of determining crystal structures which efficiently explore a significantly larger parameter space than can be practically accessed using manual job submission techniques. Indeed, structure solutions have been determined using the methods of the present invention for a number of protein and peptide crystals which could not be obtained using conventional manual submission crystallography methods. For example, structures for proteins, such as endo-galactosidase from Clostridium perfringens and lectin-1 from Pseudomonas aeruginosa, that could not be solved using conventional crystallographic methods were obtained efficiently using exemplary methods of the present invention. The methods of the present invention, therefore, overcome significant practical limitations in crystal structure determinations using manual submission techniques, and provide structure solutions for a larger set of crystalline materials than provided by conventional crystallographic methods.

In another aspect, the present invention provides methods of obtaining and evaluating electron density distributions and molecular models calculated from X-ray diffraction data. In one embodiment, the present methods employ bioinformatics data mining techniques to assess the confidence of electron density distributions and molecular models determined for crystals. In an exemplary embodiment, the present invention employs one or more confidence assessment algorithms which assign at least one confidence assessment value to each crystal structure determined for each combination of variable and fixed input parameters. An advantage of the present methods over conventional crystallographic techniques is that key parameters may be screened during data analysis. Bioinformatic data mining techniques provide a means of collecting, organizing and evaluating key data items from a large number of computational trials, in some cases thousands of computational trials. In a preferred embodiment, bioinformatic data mining analysis modules provide a means of identifying and evaluating correlations between different confidence assessment criteria, often referred to as “scores,” useful for assessing the accuracy of a calculated electron density distribution or molecular model. Evaluating a plurality of such confidence assessment criteria and correlations between such criteria provides a more accurate means of assessing uncertainty in calculated electron density distributions and molecular models that provided by evaluation of a single confidence assessment criteria. Criteria for assessing the accuracy of crystallographic computations useful for practicing the methods of the present invention include, but are not limited to, mean figure of merit of phase angles, SOLVE z-score, the number of traced residues or atoms in the polymeric chain, the connectivity index and the crystallographic R-factor. In addition, bioinformatic data mining analysis modules also provide a means of identifying and evaluating correlations between input parameters and output parameters, which may also serve as important confidence assessment criteria for assessing the accuracy of crystallographic computations. Such methods are particularly beneficial for refinement of calculated electron density distributions and molecular models by iterative structure refinement methods. Further, data mining analysis modules of the present invention are also useful for identifying different combinations of discrete X-ray diffraction data sets, which increase signal-to-noise ratios in the data and/or provide more accurate electron density distributions and molecular models when analyzed in combination than when analyzed separately.

In another aspect, the methods of the present invention provide bioinformatics visualization tools useful for directly assessing the accuracy of crystallographic calculations. Exemplary methods of the present invention provide means of illustrating input and output parameters useful for interpreting the results of a large number of computational trials, in some cases up to thousands of computational trials. The bioinformatic methods of the present invention are particularly useful for finding and characterizing complex relationship between important parameters, such input parameters, output parameters, confidence assessment criteria for assessing a calculated electron density distributions or molecular models and model fitting parameters. The ability of the present methods to efficiently organize, evaluate and display a large amount of input and output parameters supports the application of the present invention to fully or partially automated high-throughput structure determination. Further, visualization tools of the present invention assist significantly in validating structures determined by X-ray crystallography techniques. In an exemplary embodiment, three dimensional structure models predicted by bioinformatic methods based only on primary amino acid sequence are used for electron density map tracing of peptides. For example, the structures of proteins Pfu-1218608 (28.5 kDa) and Pfu-35386 (17.8 kDa) were each determined for 1.9 angstrom resolution X-ray diffraction data within 4-6 hours of beginning the calculation using three dimensional structure models obtain via bioinformatics methods. In contrast, it took one or two weeks to determine structures for these compounds using conventional crystallographic methods.

The high-throughput methods of electron density distribution and/or crystal structure determination of the present invention have substantial advantages over conventional crystallographic techniques. First, the present methods are capable of full or partial automation, which allows for efficient execution of a plurality of structure calculations over a very large input parameter space, and may eliminate or reduce operator-introduced bias. Thus, the methods of the present invention substantially increase crystal structure success rates over conventional crystallographic methods. Second, integration of data mining and visualization bioinformatics techniques into the methods of the present invention maximizes the amount of useful information which can be extracted from an X-ray diffraction set or series of X-ray diffraction data sets. In some instances the methods of the present invention allow for crystal structure determination using data collected using a single wavelength X-ray diffraction data set for structures which may only be solved via conventional methods by using multiple wavelength X-ray diffraction data. For example, a structure for the Lectin-1 protein from Pseudomonas aeruginosa was determined using the methods of the present invention using a conventional single wavelength, home X-ray source. The crystal structure of this protein, however, could only be determined via conventional crystallographic techniques using two synchrotron data sets corresponding to two different X-ray diffraction wavelengths. Third, the methods of the present invention are highly flexible and, thus, are compatible with virtually any X-ray diffraction analysis methods presently known in the art of X-ray crystallography, and can easily be adapted to newly developed X-ray diffraction analysis methods. For example, the methods of the present invention are highly suitable to structure determination using molecular replacement methods, wherein bioinformatics computational tools are used to identify structurally related proteins to serve as reference proteins used as phasing models to arrive at the electron density distributions and structures of target proteins. Bioinformatic computational tools used in the present invention are particularly useful for identifying proteins which serve as useful reference proteins even though they exhibit low homology or no homology with the target protein.

The partially and fully automated electron density distribution and structure determination methods of the present invention also provide an effective means of quickly evaluating the quality of an X-ray diffraction data set to determine if additional data collection is necessary to arrive at reliable and reproducible electron density distributions and crystal structures. Particularly, the X-ray diffraction data analysis methods of the present invention provide a real time evaluation of the adequacy of a particular X-ray diffraction data set. If it is determined that the X-ray diffraction data set is sufficient for generating a reliable electron density distribution and/or crystal structure, data collection can be terminated, thereby avoiding expenditure of unnecessary resources, such as beam time on a cyclotron X-ray source or crystallographer time. If on the other hand, it is determined that the X-ray diffraction data set is insufficient for determination of a reliable electron density distribution and/or crystal structure, additional data can be collected for the same crystal sample, for example diffraction data corresponding to a different X-ray wavelength or different crystal orientations. The ability to quantitatively assess the amount of signal averaging and redundancy necessary to achieve accurate electron density distributions and crystal structures is beneficial because it maximizes the efficiency of X-ray diffraction data collection methods and supports applications of high-throughput structure determinations.

In another aspect, the present invention provides flexible, modular computational pipelines useful for executing a large number of independent electron density distribution and/or crystal structure calculations. Computational pipelines of the present invention are ideally suited for electron density distribution and/or crystal structure determination by a wide range of analytical methods and approaches including, but not limited to, single-wavelength and multiple-wavelength anomalous diffraction methods, molecular replacement methods, isomorphous replacement methods and multiple isomorphous replacement methods. In addition, the electron density distribution and/or crystal structure determination methods and computational pipelines of the present invention are well suited for the analysis of a wide range of diffraction data including, but not limited to, X-ray diffraction, neutron diffraction, electron diffraction, single crystal diffraction, fiber diffraction, diffraction by amorphous and/or polycrystalline materials, lane diffraction and time-resolved crystallography. Further, the flexible, modular architecture of computational pipelines of the present invention make them useful for executing a wide range of other computational tasks which require screening a large parameter space. Other useful applications of these methods and concepts include, but are not limited to, making and using a Genome annotation pipeline, comparative model building based on homolog, refining crystal structures, validating crystal structures and predicting protein interactions and the formation of protein complexes using multiple sources of biological information, such as a combination of structural and functional data sources.

In another aspect, the present invention provides a method for determining the electron density distribution and/or the structure of a crystal comprising the steps of: (1) providing an X-ray diffraction data set and a set of input parameters; wherein the set of input parameters includes one or more variable input parameters and one or more fixed input parameters; wherein each of the variable input parameters have a plurality of screened values and wherein each of the fixed input parameters have a fixed value; (2) determining all possible combinations of the screened values corresponding to each of the variable input parameters and the fixed values, wherein each of the combinations comprise all of the fixed values and one screened value for each variable input parameter; (3) calculating putative crystal structures corresponding to each of the combinations; (4) assessing the confidence of each of the putative crystal structures, wherein a confidence assessment is assigned to each of the putative crystal structures; and (5) selecting the putative crystal structure having the highest confidence assessment, thereby determining the structure of the crystal. Optionally, this aspect of the present invention may further comprise the step of measuring a plurality of intensities and positions (or directions) corresponding to X-ray beams diffracted by said crystal, thereby generating said X-ray diffraction data set.

In another aspect, the present invention provides a method for determining the structure of a crystal comprising the steps of: (1) providing an X-ray diffraction data set for the crystal and a set of input parameters as input to a pipeline interface; wherein the set of input parameters includes one or more variable input parameters and one or more fixed input parameters; wherein each of the variable input parameters have a plurality of screened values and wherein each of the fixed input parameters have a fixed value; (2) determining all possible combinations of the screened values corresponding to each of the variable input parameters and the fixed values, wherein each of the combinations comprise all of the fixed values and one screened value for each variable input parameter, and wherein the pipeline interface generates as output a control file corresponding to the X-ray diffraction data and the combinations; (3) transmitting the control file to a work flow manager, wherein the work flow manager generates a computational pipeline for calculating the structure of the crystal; (4) calculating putative crystal structures corresponding to each of the combinations using the computational pipeline; (5) assessing the confidence of each of the putative crystal structures, wherein a confidence assessment is assigned to each of the putative crystal structures; and (6) selecting the putative crystal structure having the highest confidence assessment, thereby determining the structure of the crystal. Optionally, this aspect of the present invention may further comprise the step of measuring a plurality of intensities and positions (or directions) corresponding to X-ray beams diffracted by the crystal, thereby generating the X-ray diffraction data set.

In another aspect, the present invention provides automated high-throughput methods for determining structures and electron density distributions of molecules and complexes thereof, including proteins and protein complexes. In the context of this description the term automated refers to partially or fully automated methods wherein at least a portion of the steps comprising the methods are carried out without direct human intervention or supervision, such as steps carried out by a machine, such as a computer, robot or other instrumentation. In one embodiment of this aspect, the present invention provides a method for determining the structure of a protein comprising the following steps (any of which may be automated) of: (1) providing a sample containing a least one protein and, optionally, associating a barcode ID with the sample, checking the purity of the sample, for example using dynamic light scattering and PAGE techniques, and/or purifying the sample, (2) crystallizing the sample containing protein, thereby generating one or more protein crystals and, optionally, prescreening the sample having crystalline proteins with respect to the extent and quality of crystallinity, (3) generating X-ray diffraction data corresponding to the sample, for example by mounting, flash freezing and measuring one or more diffraction patterns corresponding to the sample, (4) determining the structure, electron density distribution or both of the protein(s) in the sample using high-throughput computational methods described throughout this application. Optionally, this method of the present invention may further comprise the step of salvaging protein-containing samples that do not yield diffraction quality crystals (e.g. crystals having a resolution greater than or equal to about 3 angstroms). In some methods, salvaging protein-containing samples is achieved by providing additional purification, for example using one or more different purification methods to further purify the sample, or by introducing chemical modifications to the proteins in the sample. Optionally, methods of this aspect of the present invention further comprises validating the structure and/or electron density distribution determined for the protein, for example by automated and/or manual computational methods.

The invention is further illustrated by the following description, examples, drawings and claims.

### BRIEF DESCRIPTION OF THE DRAWINGS

FIG. 1 provides a functional flow diagram illustrating an exemplary method of determining an electron density distribution and/or crystal structure from an X-ray diffraction data set employing a pipeline interface, work flow manager, crystallographic program library and output parser.

FIG. 2 provides a functional flow diagram illustrating the operation of an exemplary pipeline interface of the present invention comprising a dictionary-driven pipeline interface.

FIGS. 3A and 3B provide exemplary interface dictionaries useable in the methods of the present invention. FIG. 3A shows a dictionary comprising a text file and FIG. 3B shows a dictionary comprising a database table.

FIG. 4 provides a functional flow diagram illustrating the generation and execution of computational pipelines useful in the crystal structure determination methods of the present invention.

FIG. 5 provides a functional flow diagram illustrating an exemplary method of using a computational pipeline of the present invention.

FIG. 6 provides an exemplary internet web-based form generated in practice of the methods of the present invention.

FIG. 7 provides a functional flow diagram illustrating database control and parallelizatization aspects of exemplary methods of the present invention.

FIG. 8 provides a schematic diagram of a pipeline comprising three major components: (i) a dictionary-driven web-based user interface, (ii) a BioPERL-based workflow-management system and (iii) a set of analytical tools for harvesting and visualizing data from the resultant log files.

FIG. 9 shows an exemplary web form used to collect the input parameters required to set up a structure-determination run is generated by a dictionary-driven form generator.

FIG. 10 shows an exemplary web-based table (the SCA2Structure report webpage) showing key data items that can be easily sorted and/or filtered by the user.

FIGS. 11A and 11B provide graphical representations of pipeline success space for the PA-L1 example. A total of 55 SOLVE/RESOLVE phase sets were used as input to ARP/wARP. The gray scale scheme used represents success (number of residues fitted), with light regions indicating a near-complete model and dark regions representing cases where model building failed.

FIG. 12 shows a superposition of the experimentally determined map for Pfu-1210814 with an auto traced model.

FIG. 13 shows the structure of the Pfu-1210814 homodimer illustrating the domain swapping discovered within the dimer structure.

FIG. 14 provides a schematic diagram of a high-throughput protein-to-structure pipeline of the present invention.

FIG. 15 provides a flow diagram illustrating operation of the high-throughput pipeline from protein expression to crystallization.

### DETAILED DESCRIPTION OF THE INVENTION

“Crystal” or “crystal structure” is used synonymously in the present disclosure and refers to the three dimensional arrangement of objects, such as atoms, groups of atoms, ions, molecules and aggregates of molecules, in a crystalline material. A crystal structure may be characterized in terms of unit cells comprising the crystal, which comprise the smallest and simplest volume element that is representative of the whole crystal. In a crystal, units cells are arrange in specific lattice orientations. The present invention provides methods of determining the structures of crystals, particularly well suited for determining the structures of crystals comprising proteins, peptides, peptide-peptide complexes, protein-protein complexes; protein-lipid complexes; protein-peptide complexes; protein-cofactor complexes; oligonucleotides; carbohydrates; lipid-carbohydrate complexes and nucleic acid-protein complexes.

“Input parameters” refers to information which is provided or calculated to execute a selected computation, such as a crystal structure computation. Input parameters in the present invention are either variable or fixed. Fixed input parameters have fixed values. Variable input parameters have a plurality of screened values which range from a lower limit to an upper limit. Variable input parameters may also be characterized by a means of calculating the screened values ranging from the lower limit to the upper limit. An exemplary means of calculating the screened values ranging from the lower limit to the upper limit comprises providing a screened increment, wherein screened values are evenly distributed throughout the range provided by the lower limit and the upper limit by a constant screened increment. The present invention also includes variable input parameters wherein screened values are not evenly spaced throughout the range provided by the lower limit and the upper limit. Methods of the present invention screen a selected input parameter space for the best putative crystal structure for a given crystal by executing a plurality of crystal structure calculations corresponding to all possible combinations of screened values corresponding to each of said variable input parameters and fixed values corresponding to fixed input parameters. In an exemplary embodiment, each of the combinations comprises all of the fixed values and one screened value for each variable input parameter.

“Pipeline interface” refers to one or more algorithms and/or software components and/or set of operations, commands or rules which are capable of collecting X-ray diffusion data, user information and input parameters necessary for initiation and execution of a specific computational task or series of computational tasks. Pipeline interfaces may also provide a means of verifying X-ray diffraction data, user information and/or input parameters. Pipeline interfaces may also provide a means of organizing X-ray diffraction data, user information and/or input parameters. Pipeline interfaces may also provide a means of deriving additional information from X-ray diffraction data, user information and/or input parameters provided by a user, such as combinations of screened values corresponding to variable input parameters and fixed values corresponding to fixed input parameters which are screened in a given computation. Pipeline interfaces of the present invention may be interactive with a user or passive. A flexible dictionary-driven pipeline interface is preferred for some applications of the present invention. Pipeline interfaces and components thereof may be embodied in computer software code written in any suitable programming language, such as, XML, C or any versions of C, Perl, Java, Pascal, or any equivalents of these. Pipeline interfaces and components thereof may be embedded in or recorded on any computer readable medium, such as a computer compact disc, floppy disc or magnetic tape, or may be in the form of a hard disk or a memory chip, such as random access memory or read only memory.

“Work flow manager” refers to one or more algorithms and/or software components and/or set of operations, commands or rules which are capable of establishing the interconnectivity of a plurality of object-oriented crystallographic and bioinformatics analysis modules comprising a desired computational pipeline. Work flow managers of the present invention may also provide a means of executing a constructed computational pipeline by submitting appropriate data sets, input parameters and operation commands corresponding to a given structure calculation to a work station or computing facility. Work flow managers of the present invention may also provide a means of monitoring and controlling a given series of computational tasks to ensure that analysis modules are run in a proper sequence and to ensure computing resources are used as efficiently as possible. Workflow managers of the present invention include, but are not limited to, Bioperl-pipeline based workflow managers. Work flow managers and components thereof may be embodied in computer software code written in any suitable programming language, such as, XML, C or any versions of C, Perl, Java, Pascal, or any equivalents of these. Work flow managers and components thereof may be embedded in or recorded on any computer readable medium, such as a computer compact disc, floppy disc or magnetic tape, or may be in the form of a hard disk or a memory chip, such as random access memory or read only memory.

“Output parser” refers to one or more algorithms and/or software components and/or set of operations, commands or rules which provide for rapid analysis and/or visualization of the output of a computational pipeline and/or the various outputs of discrete analysis modules comprising a computational pipeline. Output parsers of the present invention may also provide a means of parsing out key data items useful to crystallographers and bioinformatitions in evaluating and refining electron density distributions and molecular models determined by the present methods, and may also provide a means of assessing the confidence of putative crystal structures, particularly putative crystal structures corresponding to combinations of fixed and variable input parameters. Output parsers and components thereof may be embodied in computer software code written in any suitable programming language, such as, XML, C or any versions of C, Perl, Java, Pascal, or any equivalents of these. Output parsers and components thereof may be embedded in or recorded on any computer readable medium, such as a computer compact disc, floppy disc or magnetic tape, or may be in the form of a hard disk or a memory chip, such as random access memory or read only memory.

“Resolution” is a characteristic relating to the ability to distinguish discretely observable elements in a measurement or series of measurements. In the context of X-ray crystallography, resolution relates to the ability to ascertain three-dimensional information about the positions of objects, such as atoms, groups of atoms, ion ands molecules, in a material, such as a crystal. In certain aspects of the present invention, resolution relates to the minimum distance which separates discretely observable elements of electron density identified via the analysis of X-ray diffraction data. In other aspects of the present invention, resolution relates to the minimum distance which separates individual scatterers, such as atoms and/or groups of atoms, which are observable via the analysis of X-ray diffraction data. Use of the term resolution in the present invention is intended to be consistent with usage of this terms by those skilled in the art of X-ray crystallography. The upper limit of the resolution of an X-ray diffraction data set is typically established by a number of experimental parameters including, but not limited to, the wavelength of the X-ray beam, the detector area and the signal-to-noise ratio of the data. In exemplary methods of the present invention, X-ray diffraction data is analyzed and/or interpreted in a manner providing different resolutions, for example resolutions screened over the range of about 0.5 Å to about 100 Å. Although high resolution analysis may allow differentiation of closely spaced scatterers, higher resolution analysis of X-ray diffraction data typically results in lower signal-to-noise ratios. Accordingly, methods of the present invention screen the resolution of the data analysis to identify an analysis resolution providing the best electron density distribution and/or crystal structure.

“Operational communication” refers to two elements, such as algorithms, subroutines, computer processors, computer programs/software, that are capable of communicating in some manner. Exemplary elements in operational communication are capable of passing input and/or output between them. Elements in operational communication may be in one way communication or in two way communication.

The terms “peptide” and “polypeptide” are used synonymously in the present disclosure, and refer to a class of compounds composed of amino acid residues chemically bonded together by amide bonds (or peptide bonds). Peptides and polypeptides also include polymeric compounds composed of amino acid residues including one or more modified amino acid residues. Modifications can be naturally occurring or non-naturally occurring, such as modifications generated by chemical synthesis. Modifications to amino acids in peptides or polypeptides include, but are not limited to, phosphorylation, lipidation, methylation, prenylation, sulfonation, hydroxylation, acetylation, methionine oxidation, alkylation, acylation, carbamylation, iodination and the addition of cofactors.

“Protein” refers to a class of compounds comprising one or more polypeptide chains and/or modified polypeptide chains. Proteins may be modified by naturally occurring processes such as post-translational modifications or co-translational modifications. Exemplary post-translational modifications or co-translational modifications include, but are not limited to, phosphorylation, lipidation, prenylation, sulfonation, hydroxylation, acetylation, methionine oxidation, the addition of cofactors, proteolysis, and assembly of proteins into macromolecular complexes. Modification of proteins may also include non-naturally occurring derivatives, analogues and functional mimetics generated by chemical synthesis. Exemplary derivatives include chemical modifications such as alkylation, methylation, acylation, carbamylation, iodination or any modification that derivatizes the protein. In the present invention, proteins may be modified by labeling methods, such as metabolic labeling, enzymatic labeling or by chemical reactions. Proteins may be modified by the introduction of stable isotope tags, for example as is typically done in a stable isotope dilution experiment. Proteins of the present invention may be derived from sources, which include but are not limited to cells, expression systems, cell or tissue lysates, cell culture medium after cell growth, whole organisms or organism lysates or any excreted fluid or solid from a cell or organism.

The present invention provides high-throughput methods for determining electron density distributions and/or crystal structures from X-ray diffraction data. In particular, the present invention provides electron density distribution and/or crystal structure determination methods employing flexible, high-throughput modular computational pipelines. The present invention also provides electron density distribution and/or crystal structure determination methods employing a pipeline interface, work flow manager and/or output parsers that optimize the amount of structural information derived from an X-ray diffraction data set, and increase the efficiency of calculating crystal structures from X-ray diffraction data.

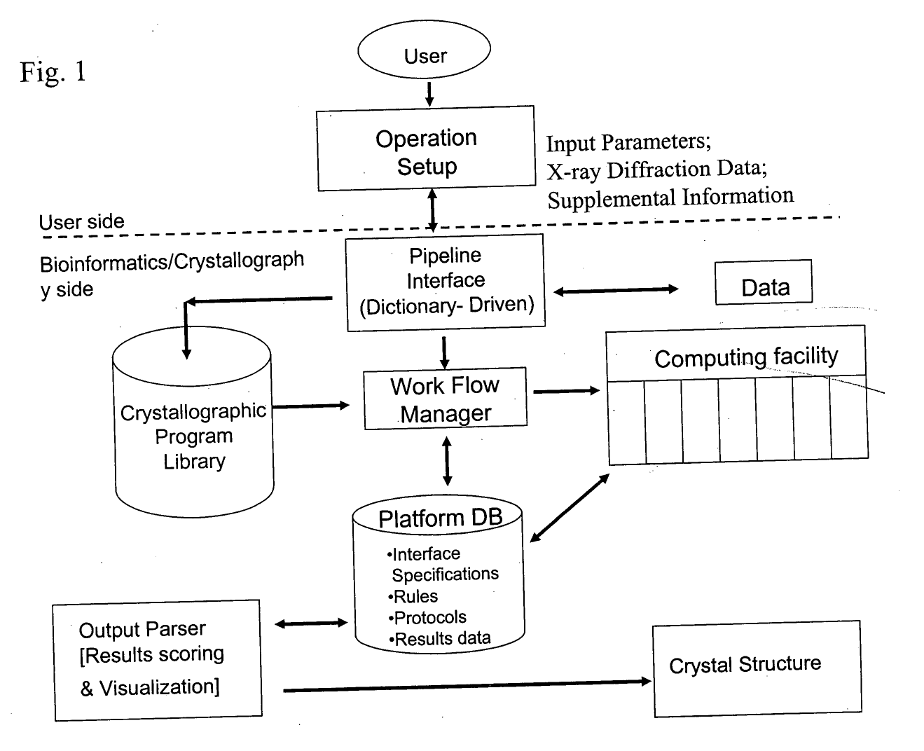

FIG. 1 provides a functional flow diagram illustrating an exemplary method of determining an electron density distribution and/or crystal structure from an X-ray diffraction data set employing a pipeline interface, work flow manager, crystallographic program library and output parser. As shown in FIG. 1, a user initiates a crystal structure determination by providing the pipeline interface with variable input parameters, fixed input parameters and an X-ray diffraction data set. The pipeline interface acts to collect and organize key information useful for the electron density distribution and/or crystal structure calculation, such as the X-ray diffraction data and input parameters. Optionally, the pipeline interface may also verify that the information provided by the user is adequate for performing a selected electron density distribution and/or crystal structure calculation. Additionally, information verification provided by the pipeline interface may optionally include the step of comparing the collected variable input parameters, fixed input parameters and/or X-ray diffraction data to a set of predefined parameter ranges and/or expected X-ray diffraction data ranges in order to identify any user introduced errors in the entry of this information. This additional verification step is also useful for avoiding unnecessary screening of parameter space not relevant to a given crystal structure calculation, and constraining expenditure of computational resources during the structure determination to a reasonable amount in light of the availability and extent of such resources. In the exemplary embodiment shown in FIG. 1, the pipeline interface is interactive (as represented by the double arrow) and gathers the X-ray diffraction data and input parameters required to perform a selected crystal structure calculation by prompting or requesting specific information from the user. In an exemplary embodiment, the pipeline interface gathers the necessary information through the use of internet web-based forms and/or XML control files.

Also referring to FIG. 1, the pipeline interface is capable of generating an output comprising one or more control files, which contain information useful for calculating electron density distribution and/or crystal structures, such as the variable input parameters, fixed input parameters and X-ray diffraction data. Optionally, the control file generated by the pipeline interface may also comprise information derived from the input parameters and X-ray diffraction data, such as all combinations of screened values for variable input parameters and fixed values for fixed parameters. The control file generated by the pipeline interface is transmitted to the work flow manager. The work flow manager receives the control file as input and generates at least one computational pipeline using information contained in the control file provided by the pipeline interface. In addition, the pipeline is in operational communication with a crystallographic program library comprising information defining a plurality of discrete crystallographic and bioinformatics analysis modules. Operation of the work flow manager establishes the interconnectivity of selected, object-oriented crystallographic and bioinformatics analysis modules defined in the crystallographic program library. The identities of analysis modules and manner of linking analysis modules for a given computational pipeline may be specified by input parameters supplied by the user, input parameters generated by the pipeline interface or may be specified by operation of the work flow manager itself. Optionally, the work flow manager may link specified analysis modules using reformatting programs, such as input wrappers, output wrappers and/or run wrappers to ensure compatibility between the input and output formats of different analysis modules. Optionally, the work flow manager may generate one or more additional computational pipelines which may be used to determine crystal structures using additional computational techniques and crystallographic analysis methods.

Upon generation of an appropriate computational pipeline (or pipelines) for a selected crystallographic structure determination, a plurality of independent crystal structure calculations are initialized and executed using a computing facility comprising a computer processor, computing cluster, multiprocessor computer, or any combinations or equivalents thereof. The plurality of independent crystallographic calculations may correspond to all possible combinations of screened values for variable input parameters and fixed values for fixed input parameters. In an exemplary embodiment, each combination of screened and fixed values comprises all of the fixed values and one screened value for each variable input parameter. Combinations of variable and fixed input parameters may be determined by operation of the pipeline interface, by operation of the work flow manager or by a combination of operations of the pipeline interface and work flow manager. The work flow manager may also manage which processor in a multiprocessor computer or computing cluster is assigned a given operation or series of operations.

As shown in FIG. 1, the work flow manager is in operational communication with a computing facility, such as a work station, a computing cluster, Linux cluster, grid computing cluster or multiprocesser work station or computer. In the embodiment shown in FIG. 1, the work flow manager submits appropriate data sets, input parameters and operation commands to initiate and execute an independent structure calculation corresponding to each combination of fixed and variable input parameters screened. Preferably, independent crystal structure calculations for each combination of fixed and variable input parameters are calculated in parallel, for example running parallel on a computer cluster, to optimize the efficiency of the structure determination and to increase the overall rate of electron density distribution and/or crystal structure determination.

As shown in FIG. 1, the methods of the present invention also provide a platform database in operational communication with the computing facility and the work flow manager. The output of individual analysis modules comprising the computational pipeline and output of the computational pipeline itself may be provided as input to the platform database. The work flow manager is configured to periodically access the platform database for monitoring and controlling computational tasks in a given structure calculation to ensure that analysis modules are run in proper sequence, verify key computational steps in a given calculation are properly executed, monitor computational steps in a given calculation and to ensure computing resources are managed in an efficient manner. As also shown in FIG. 1, one or more output parsers may be in operational communication with the platform database, allowing rapid analysis and/or visualization of the various outputs of discrete, analysis modules comprising a given computational pipeline. Use of output parsers in the present invention is beneficial because it provides the user with the ability to directly evaluate the progress of a given structure calculation during execution, and may also enable a user to add or improve backend pipeline analysis modules without interrupting the usage of the pipeline. This aspect of the invention provides added flexibility, and allows for increased operator oversight and control during electron density distribution and/or structure calculations.

Execution of independent crystal structure calculations by combined operation of the work flow manager and computing facility generates as an output a plurality of putative crystal structures corresponding to each of the screened combinations of input parameters. Each calculated putative crystal structure is provided as input to the platform database. The confidence of each putative crystal structure may also be assessed by operation of confidence assessment analysis modules nested within a given computational pipeline. Alternatively, the confidence of each putative crystal structure may be assessed by operation of one or more independent output parsers in operational communication with the platform database. Preferably, one or more confidence assessments are assigned to each putative crystal structure. In an exemplary embodiment, a plurality of confidence assessments are assigned to each putative crystal structure and are combined via a cumulative confidence assessment algorithm to provide a cumulative confidence value for each putative crystal structure. The structure of the crystal under investigation is determined by selecting the putative crystal structure corresponding to the highest confidence assessment or cumulative confidence value. In the present invention, confidence assessments may be provided by linked bioinformatics or crystallography analysis modules in the computational pipeline or by independent output parsers in operational communication with the platform database.

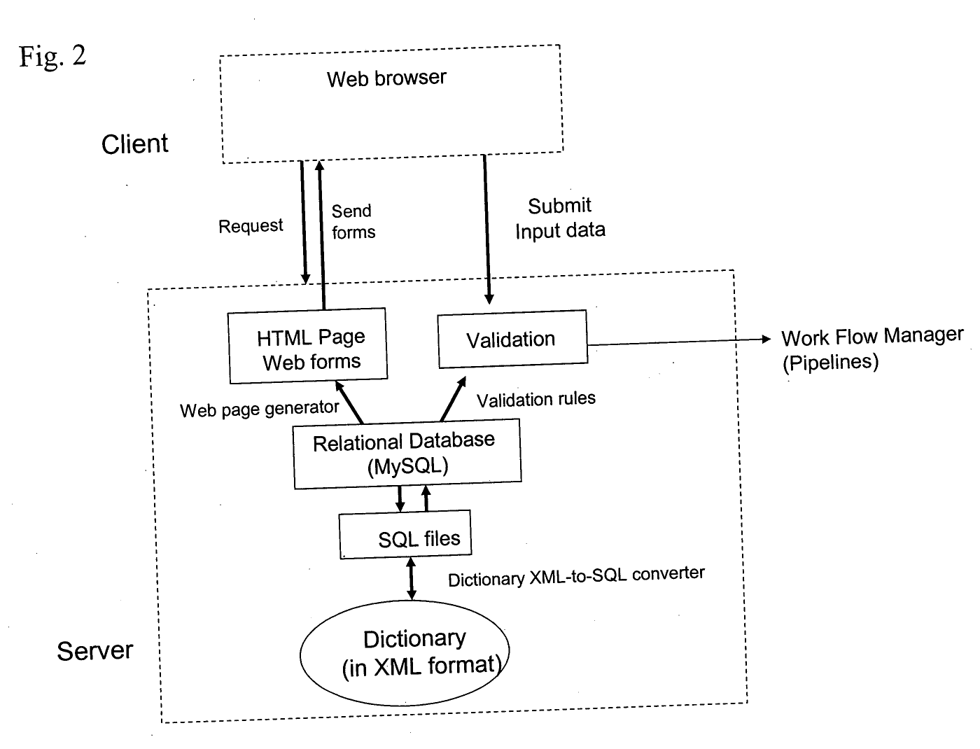

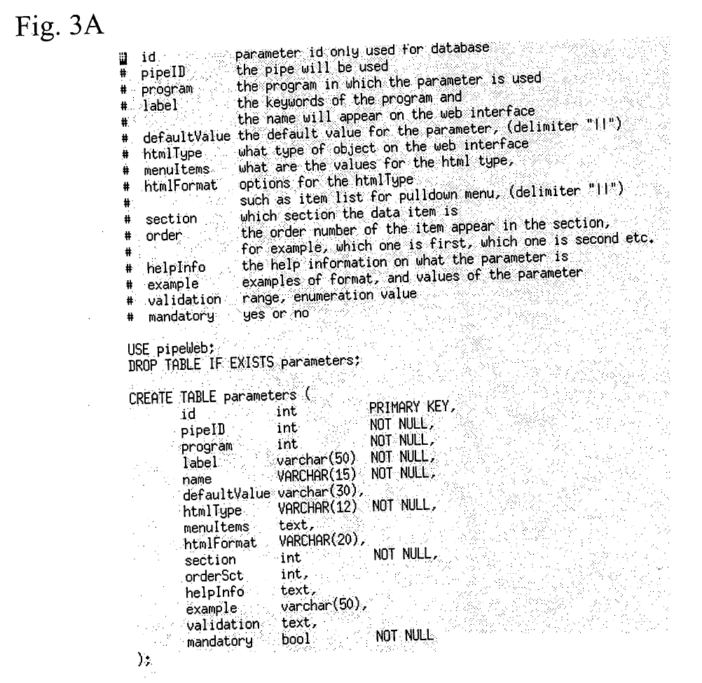

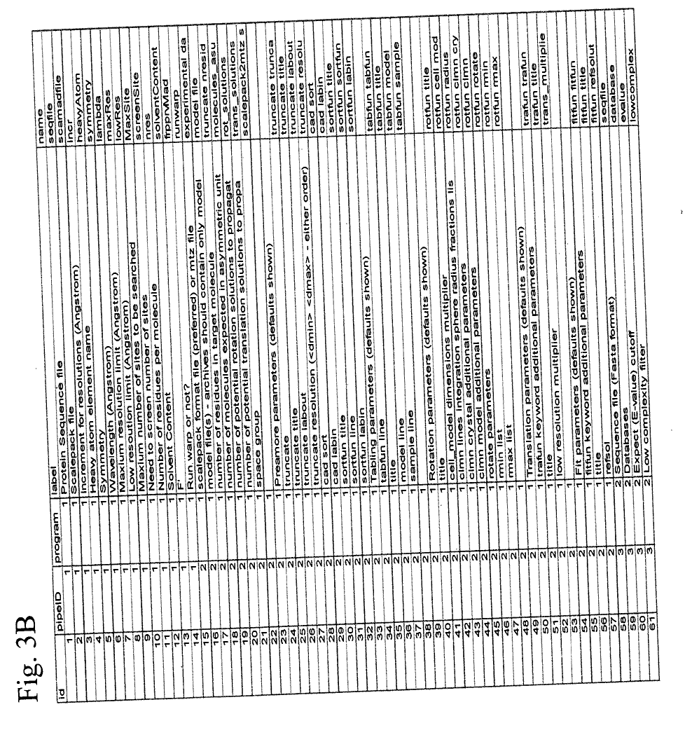

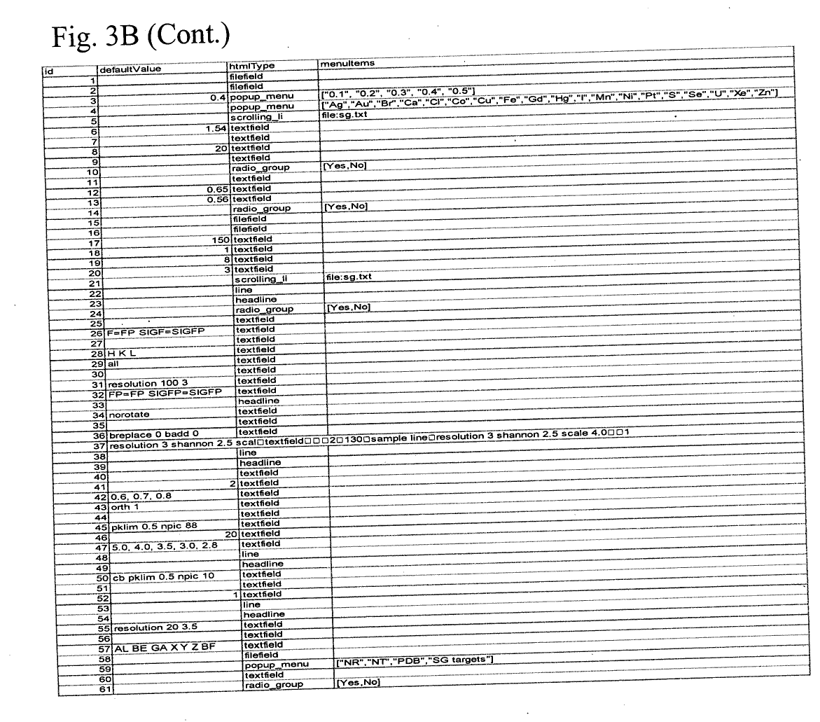

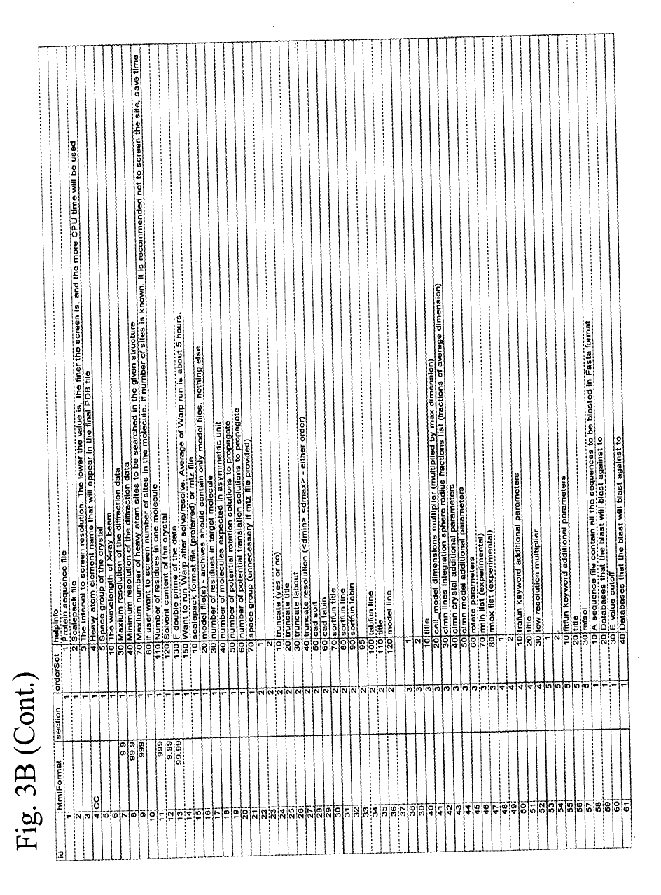

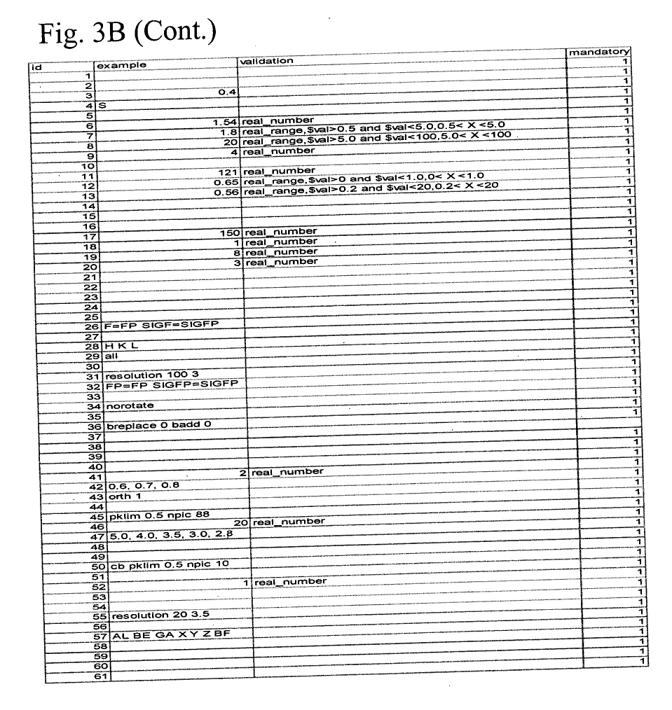

FIG. 2 provides a functional flow diagram illustrating the operation of an exemplary pipeline interface of the present invention comprising a dictionary-driven pipeline interface. As shown in FIG. 2, a user initiates a crystal structure determination by providing a request to the dictionary-driven pipeline interface. In an exemplary embodiment, the request comprises key words which indicate what functional task or series of functional tasks are desired, such as which electron density distribution and/or crystal structure analytical methods are to be used to determine a crystal structure from X-ray diffraction data. The dictionary-driven pipeline interface receives the request as input and generates one or more forms, such as HTML internet web page forms, which are transmitted to the user for the purpose of collecting the input parameters and X-ray diffraction data necessary for the desired crystal structure determination. The forms generated by the dictionary-driven pipeline interface of the present invention indicate to the user which input information and X-diffraction data is required for a selected crystal structure calculation. As shown in FIG. 2, the dictionary-driven pipeline interface uses a relational database derived from a dictionary to generate the forms using the request provided by the user. In an exemplary embodiment, the dictionary is provided in XML format. FIGS. 3A and 3B shows exemplary interface dictionaries useable in the methods of the present invention. FIG. 3A shows a dictionary comprising a text file and FIG. 3B shows a dictionary comprising a database table. Exemplary dictionaries useful in dictionary-driven pipeline interfaces of the present invention can easily be modified to provide for different functional applications.

Referring again to FIG. 2, forms generated by the dictionary-driven pipeline interface are transmitted as output to the user. The user submits the filled-in forms along with specific information indicated in the forms to the pipeline interface, such as variable input parameters, fixed input parameters and X-ray diffraction data. Using a series of validation rules provided by the relational database, the pipeline interface validates the information supplied by the user. If the information provided by the user is deficient in some way or incomplete, the dictionary-driven pipeline interface generates and provides the user with additional forms identifying the information required to complete a selected crystal structure determination and/or any problems with the originally input data and input parameters. If the information provided by the user is complete, the dictionary-driven pipeline interface generates one or more control files which may be used to generate one or more computational pipelines for determining crystal structures form the X-ray diffraction data provided by the user. In an exemplary embodiment, the dictionary-driven pipeline interface generates a control file which is provided as input to a work flow manager capable of generating the desired computational pipeline.

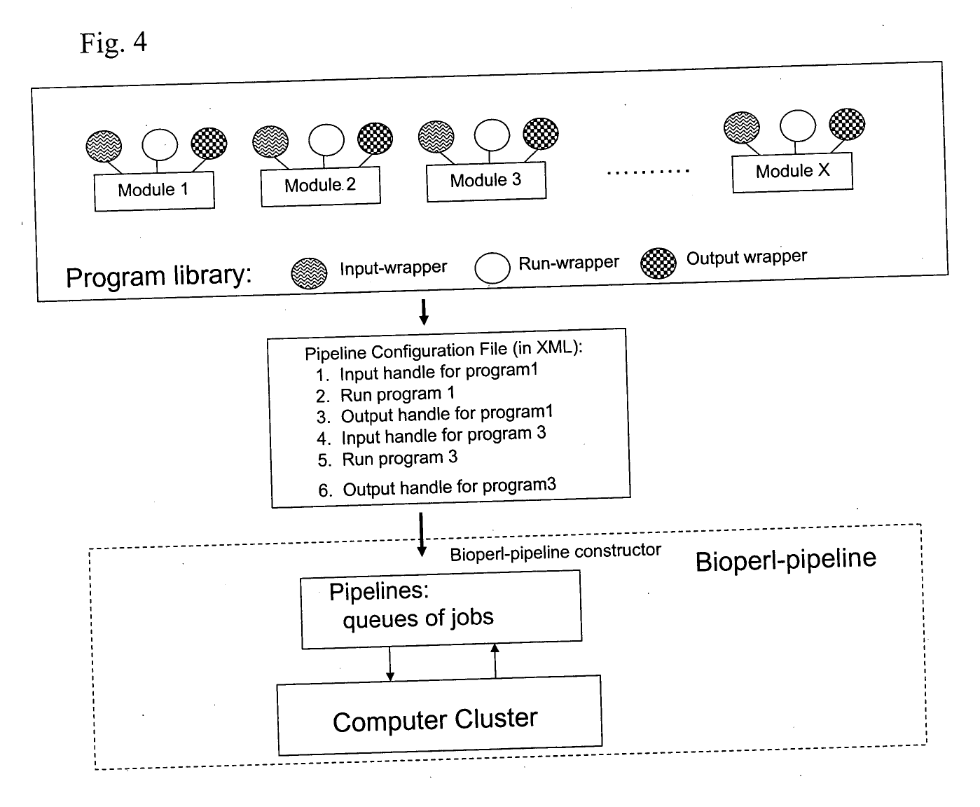

FIG. 4 provides a functional flow diagram illustrating the generation and execution of computational pipelines useful in the methods of the present invention. As shown in FIG. 4, a program library containing bioinformatics and crystallographic analysis modules is used to generate a computational pipeline comprising a plurality of selected analysis modules, which are integrated in a specified manner to achieve a desired functional task. In an exemplary embodiment, analysis modules may be linked using a plurality of reformatting programs, such as input wrappers, run wrappers and output wrappers, to ensure that the output of one module is in a format compatible with the next analysis module in the pipeline. The modular nature of computational pipelines of the present invention allows a user to customize a given structure determination to address problems unique to a given crystal structure or X-ray diffraction data set. The modular nature of computational pipelines also allows for efficient modification of backend analysis modules in the pipeline and allows addition of new modules without interrupting the progress of a given calculation. This functional aspect of the present invention also increases the flexibility of the crystal structure determination methods of the present invention.

Referring again to FIG. 4, the constructed computational pipeline is used to generate a pipeline configuration file comprising a list of commands and/or operations necessary for executing a given crystal structural calculation. Exemplary configuration files are in XML format. The commands and operations specified in the configuration file initialize analysis modules, execute analysis modules, direct output generated by executing a given analysis module to be received as input by another analysis module and ensure inter-module compatibility by reformatting module output and input. As shown in FIG. 4, the pipeline configuration file is provided to a pipeline constructor, such as a Bioperl-pipeline constructor, and the calculation is executing in stages by submitting jobs and/or functional tasks to the nodes of a computer cluster.

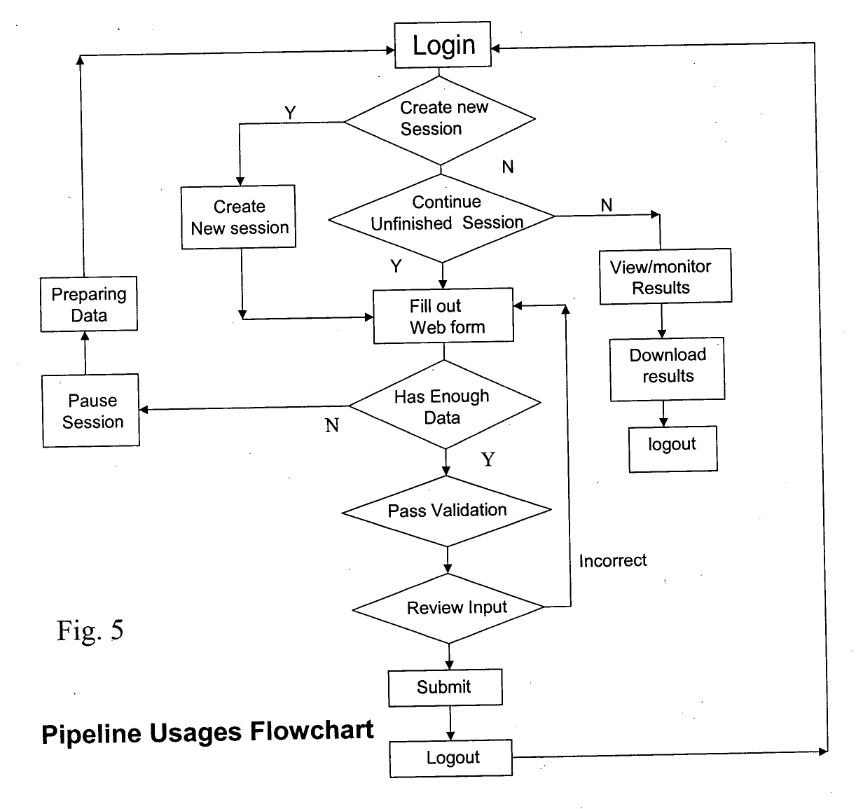

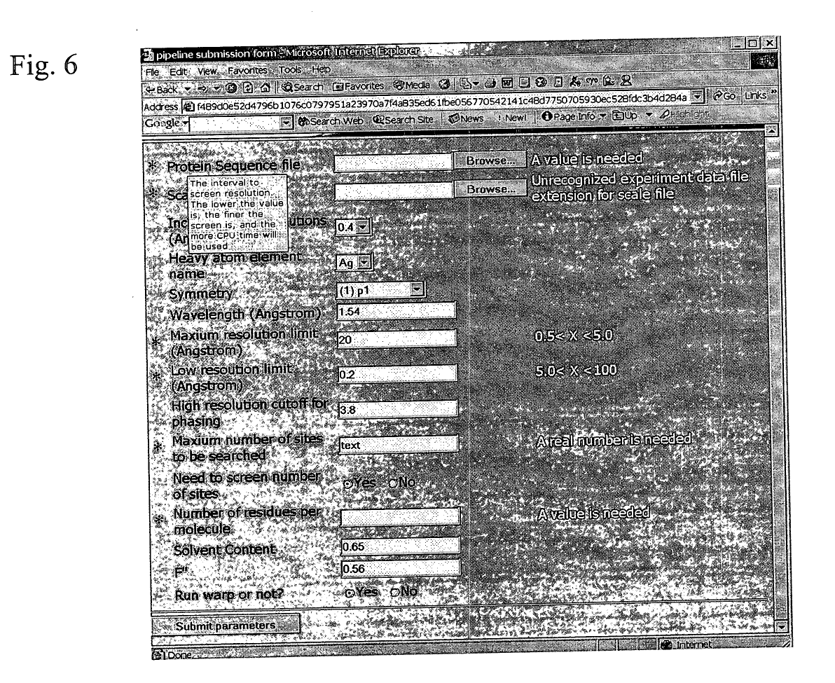

FIG. 5 provides a functional flow diagram illustrating an exemplary method of using a computational pipeline of the present invention. As indicated in FIG. 5, a user initiates a crystal structure calculation by logging into a server. Upon logging in, the user is queried as to whether he or she wishes to create a new session or wishes to continue an unfinished session. If the user indicates a desired to create a new session or continue an unfinished session, an internet web page form is generated and provided to the user indicating the input parameters and X-ray diffraction data required for carrying out a desired crystal structure calculation. FIG. 6 provides an exemplary pipeline submission internet web page form generated in practice of the methods of the present invention. If the user indicates a desired not to create a new session or continue an unfinished session, the user is linked with the output of a previously executed crystal structure determination, wherein the user may view results, monitor results or download results.

Referring again to FIG. 5, a user creating a new session or continuing an unfinished session may fill out and submit the internet web page form along with any necessary or optional additional information and/or data files indicated on the internet web page form. Next, the input information provided by the user is evaluated. If enough information is provided by the user to perform a desired crystal structure calculation, the filled in internet web page form is validated, and then evaluate to ensure that the input parameters and X-ray diffraction data provided are within predetermined ranges to avoid user input errors and to ensure that computational resources are adequate for the specified task, range of screened parameters and resolution of the screen of input parameter space. If any of the input parameters and/or X-ray diffraction data provided by the user do not fall within the corresponding predetermined ranges, one or more new internet web page forms are generated requesting resubmission of the information within indicated predetermined ranges. If all the input parameters and X-ray diffraction data provided by the user fall within the corresponding predetermined ranges, the information is submitted, and the appropriate computational pipeline is generated and executed.

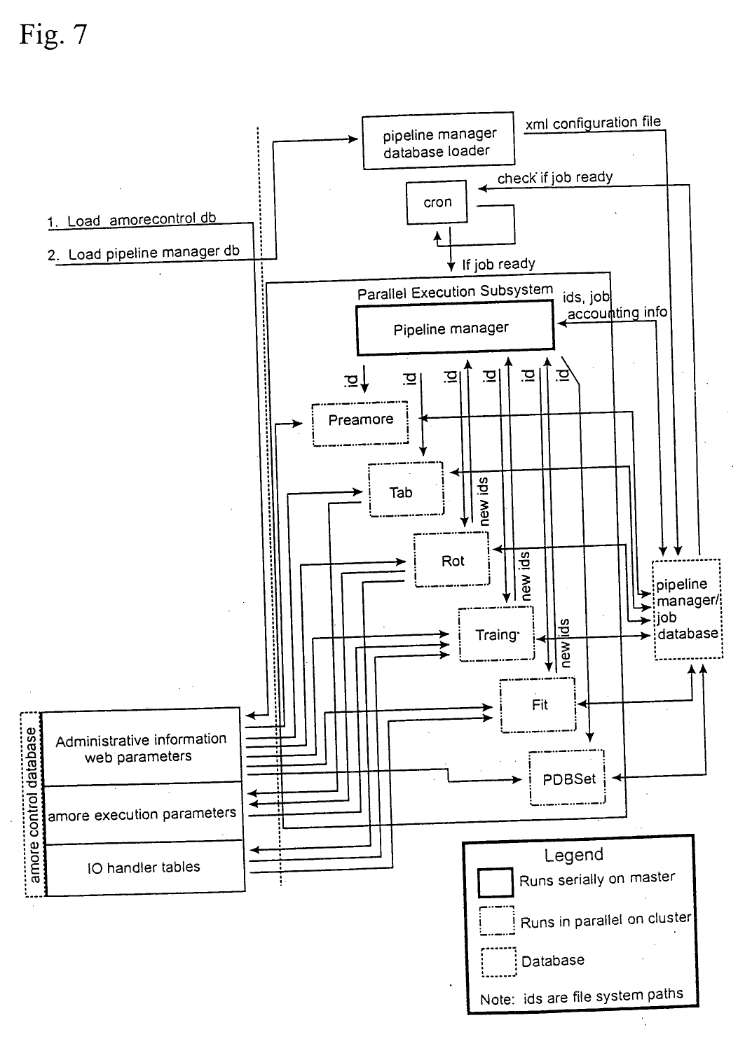

FIG. 7 provides a functional flow diagram illustrating database control and parallelization aspects of exemplary methods of the present invention using molecular replacement methods. As shown in FIG. 7, a user first inputs the necessary data using a Web interface. The input data is stored in a relationship database and an XML configuration file is generated for a work flow manager (in this case a pipe manager) to assemble and execute the pipeline. The pipeline indicated comprises a series of pipeline analysis modules (PreAMORE, Tab, Rot, Traing, Fit, and PDBset) which are executed to carry out a calculation using molecular replacement techniques. PreAMORE and Tab modules are executed first and generate input for the Rot module. The Rot module is them executed. Next, Traing, Fit, and PDBset modules are run sequentially. In the present embodiment, Rot, Traing, Fit, and PDBset modules require the output of a previous module as its input. The information exchange between two modules is achieved through a relational database to improve consistency and provide better performance. The work flow manager manages all jobs running on a computer cluster.

In the present invention, determining putative crystal structures for a range of combinations of fixed and variable input parameters provides an effective means of searching or screening a selected parameter space for a crystal structure that best fits the observed X-ray diffraction data and any supplementary structure related information, such as peptide sequence and known bond angles, bond lengths, secondary structure motifs and tertiary structural motifs. Exemplary methods of the present invention screen between about 250 to about 2000 combinations of screened values and fixed values for a given crystal structure determination. Useful variable input parameters for the present methods include, but are not limited to, the maximum resolution of the X-ray diffraction data, the minimum resolution of the X-ray diffraction data, the number of heavy atom scatterers in a unit cell of the crystal, the solvent content of the crystal, the number of molecules in an asymmetric unit of the crystal; the F″ of the X-ray diffraction data set (a measure of the strength of anomalous scattering); the angular alignment of a reference structure, and the symmetry space group of the crystal. In an exemplary embodiment, a lower limit, an upper limit and a screening increment is provided for each variable input parameter. Table 1 provides a list of exemplary lower limits, upper limits and screening increments for several variable input parameters.

TABLE 1
Exemplary screening values for selected variable input parameters.

| | Lower | | Screening | Numerical |
|---|---|---|---|---|
| Input parameter | Limit | Upper Limit | Increment | Constraints |
| Maximum resolution | 0.5 Å | 5 Å | 0.1 Å | None |
| of the diffraction | | | 0.2 Å | |
| data | | | 0.3 Å | |
| | | | 0.4 Å | |
| | | | 0.5 Å | |
| Minimum resolution | 5 Å | 100 Å | 0.1 Å | None |
| of the diffraction | | | 0.2 Å | |
| data | | | 0.3 Å | |
| | | | 0.4 Å | |
| | | | 0.5 Å | |
| Number of heavy | 1 | 200 | 1 | Integer |
| atom scatterers in a | | | | |
| unit cell of the | | | | |
| crystal | | | | |
| Solvent content of | 0 | 1 | 0.05 | None |
| the crystal | | | | |
| Number of | 1 | 100 | 1 | Integer |
| molecules in an | | | | |
| asymmetric unit of | | | | |
| the crystal | | | | |
| F″ of the X-ray | 0.2 | 20 | 0.01 | None |
| diffraction data set | | | 0.02 | |

| | |
|---|---|
| Symmetry Space | All possible space groups for a given material. |
| Group | For crystals comprising proteins this entails 72 |
| | different symmetry space groups. |

The resolution of X-ray diffraction data in a data set is a particularly important variable input parameter that is screened in exemplary methods of the present invention, particularly methods which employ multiple or single wavelength anomalous scattering crystal structure determination methods. Ascertaining strong and clear anomalous signals from intensity measures comprising crystal diffraction patterns is important to providing quality, acceptable phase information, including break phase ambiguities for an initial electron density map. Indeed, in many situations strong and clear anomalous signals are critical for achieving successful crystal structure determinations. The anomalous signal in X-ray diffraction data is the result of anomalous scattering of internal electrons of an atom, typically a heavy atom such as S, Se, P, Cl or metals. Anomalous signals in X-ray diffraction data, however, are very often small and, hence, extremely difficult to accurately quantify. In addition, anomalous signals can be affected by temperature (due to changes in internal vibrations), which results in decreasing its relatively small magnitude of value even further when it is derived from higher resolution diffraction data. In these circumstances, the anomalous signal is often comparable in magnitude to the noise level observed in the data, and sometimes the anomalous signal is even lower than the noise. The weak anomalous signals in those cases not only produces poor electron density maps, but because of the influence of noise, it can result in a reversion of the phase angle by 180 degrees. This type of reversion, which is more likely to occur at high resolution, has been demonstrated to be more damaging in deteriorating and obscuring an electron density map than the gains provided by the additional phasing information in higher resolution data. Therefore, a tradeoff often has to be made when interpreting X-ray diffraction data to get as much as useful diffraction information from relative high resolution data and avoid introducing damaging phase information in high resolution data. Usually the balance point in this compromise is extremely hard to identify using a fix formula or single analytical approach. Methods of the present invention approach a determination of the optimal resolution for interpreting X-ray diffraction data by screening this parameter over a wide range of possible resolution integrals and calculating crystal structures for all combinations of screened values relating to X-ray diffraction data resolution. This method provides a practical means of identifying the resolution cutoff providing the best crystal structure determination. Substantial increases in the solvability and accuracy of crystal structure determinations have been realized using the resolution screening methods of the present invention. In addition, these methods harness the increasingly affordable computing approach to the problem determining accurate structures of crystals from X-ray diffraction data.

In a particular embodiment of the present invention, the resolution of the X-ray diffraction data set using during data analysis is screened by providing screened values for two variable input parameters corresponding to the maximum resolution of the X-ray diffraction data and the minimum resolution of the X-ray diffraction data. For example, both input parameters may be characterized in terms of a lower limit, upper limit and a screening increment, which provides a means of determining the screened values of each resolution related variable input parameter. Crystal structure determination methods of the present invention which screen both the maximum resolution of the X-ray diffraction data and the minimum resolution of the X-ray diffraction data have been demonstrated to provide crystal structures for crystals whose structures were not able to be determined using conventional X-ray crystallographic analysis methods.

The present invention provides coarse screening crystal structure determination methods employing relatively large screen increments corresponding to selected variable input parameters, and also provides fine screening crystal structure determination methods employing relatively small screen increments corresponding to selected variable input parameters. In addition, the present invention provides methods which combine both coarse and fine screening methods to efficiently determine crystal structures. For example, a coarse screen may be initially executed corresponding to a selected wide parameter space to identify a narrower, selected parameter space wherein a crystal structure solution is probable. The narrower parameter space identified by operation of the coarse screen may be subsequent evaluated using a fine screening analysis to determine the best crystal structure.

The present invention is capable of determining crystal structures using a wide range of X-ray diffraction data. “X-ray diffraction data set” and “X-ray diffraction data” are used synonymously in the present disclosure and refer to data acquired in an X-ray diffraction experiment. X-ray diffraction data may comprise a plurality of intensities, intensity distributions, positions, directions and/or phases of X-rays diffracted from a material, such as a crystal. X-ray diffraction data may correspond to a single X-ray wavelength or a plurality of X-ray wavelengths. X-ray diffraction data may correspond to a single crystal orientation or a plurality of crystal orientations. The methods of the present invention may additionally comprise the step of measuring X-ray diffraction data used in a crystal structure determination. Any method of measuring and collecting X-ray diffraction data may be used in the methods of the present invention including but not limited to defractometric methods, methods using area detectors, methods using single and/or multiple wavelength home sources, and methods using synchrotron X-ray sources

The methods of the present invention, computational pipelines, analysis modules and/or pipeline control algorithms, such as pipeline interfaces, work flow managers, output parsers, of the present invention may be performed, operated, controlled, monitored or executed using computers, computing clusters or processing systems capable of running application software. Examples of computers and computer resources useful in the present methods include microcomputers, such as a personal computer, multiprocessor computers, work station computers, computer clusters and grid computing cluster or suitable equivalents thereof. Preferably, algorithms and software of the present invention are embedded in or recorded on any computer readable medium, such as a computer compact disc, floppy disc or magnetic tape or may be in the form of a hard disk or memory chip, such as random access memory or read only memory.

As appreciated by one skilled in the art, computer software code embodying the methods and algorithms of the present invention may be written using any suitable programming language. Computer languages useable in practicing the methods of the present invention include, but are not limited to, XML, C or any versions of C, Perl, Java, Pascal, or any equivalents of these. While it is preferred for some applications of the present invention that a computer be used to accomplish all the steps of the present methods, it is contemplated that a computer may be used to perform only a certain step or selected series of steps in the present methods.

All references cited in this application are incorporated in their entireties by reference herein to the extent that they are not inconsistent with the present disclosure in this application. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques specifically described herein are intended to be encompassed by this invention.

### EXAMPLE 1

### Determining Protein and Peptide Crystal Structures Using Single wavelength and Multiple Wavelength Anomalous Scattering Techniques

The methods of the present invention were used to determine electron density distributions and crystal structures of proteins, peptides and complexes of these using phase information derived from anomalous scattering observed in the X-ray diffraction data. The results of these studies indicate that the present methods increase the success rate of structure solving by taking advantage of parallel structure calculations using modular computational pipelines which explore a much larger parameter space than is feasible with manual job submission-based crystallographic methods. Structure solutions to proteins and peptides have been obtained in several cases where conventional, manual submission crystallography approaches have failed.

1.a. Introduction

Owing to the continued improvements in hardware, software and experimental techniques over the past decade, X-ray diffraction experiments produce data of higher quality and resolution than ever before. However, crystal structure determination, in the case of macromolecules, continues to be a complicated multi-step process that typically includes identification and refinement of the phasing substructure (heavy atoms or anomalous scatterers), generation of protein phases, density modification, tracing the peptide chain, building and refining the protein model, validation and publication. Because of the complexity of the protein crystal structure determination, many bottlenecks and decision points remain that slow down the process.

Automation of some aspects of protein structure determination has advanced considerably. Program packages such as SOLVE/RESOLVE (Terwilliger, 2002), ARP/wARP (Perrakis et al., 1999) and CCP4 (Collaborative Computational Project, Number 4, 1994) have partially automated protein structure determination, but the crystallographer's attention is still required in order to answer the following questions. (i) Is the data set of sufficient quality to permit solution of the structure? (ii) Among several alternative strategies, methods and computer programs, all with specific strengths and weaknesses, which one(s) is (are) most appropriate for the given problem? (iii) What are the appropriate values for the input parameters for each program? (iv) If more than one source of data (native, derivatives etc.) is available, which data set should be used? Or, what is the best way to combine them, if appropriate? (v) At each step, do the results/output indicate that one can reasonably proceed to the next step? If not, should more and/or better data be collected? The crystallographer generally addresses these questions in a trial-and-error process based on his/her experience by adjusting the parameters based on the previous results and repeating the computation. This process is not only very inefficient owing to the limitations of a manual operation, but it also often results in missing a solution even if the data could provide one. Increased throughput requirements of the structural genomics era aggravate this shortcoming. Continued growth in computational power and maturing computer cluster technology gives today's crystallographer computer resources unheard of a decade ago and, together with improved algorithms and new approaches, has significantly reduced the average time of the structure-determination process (data collection to Protein Data Bank submission) from a number of months to a matter of days. The Southeast Collaboratory for Structural Genomics (SECSG), like other structural genomics centers (Norvell, 2000), is pursuing the integration of different crystallographic programs into a structure determination pipeline. The availability of a 128-processor computer cluster and a custom dictionary-driven workflow-management system allows multiple structure-determination jobs to be run in parallel, with each job run with a slightly different set of program input parameters. This approach increases the success rate of structure solution by: (i) exploring a significantly larger fraction of program parameter space and (ii) by sampling program parameter space in finer increments than is feasible with manual job submission. Using this approach, we have found structure solutions in a number of cases where conventional ‘crystallographer-directed’ screening of program parameter space had failed.

The SCA2Structure pipeline described here is designed and implemented using the BioPERL pipeline platform with the aim of producing a partially refined structure from a set of scaled single wavelength anomalous scattering (SAS) data. The current version integrates SOLVE/RESOLVE, ISAS, part of the CCP4 suite (Collaborative Computational Project, Number 4, 1994), ARP/wARP and REFMAC, also part of CCP4, into a pipeline that is capable of spawning hundreds of jobs in parallel on a Linux cluster using various combinations of programs and/or input-parameter values. The results provided here demonstrate that use of the present methods dramatically increases the efficiency and success rate of the structure-determination process. The present pipeline approach not only increases the speed of determining a crystal structure, it also increases the likelihood of success owing to finer sampling of program parameter space.

SCA2Structure has been used to solve over 30 structures (Protein Data Bank; Berman et al., 2000) with codes 1l7l, 1nnh, 1nnq, 1nnw, 1pry, 1ups, 1ryq, 1s36, 1sen, 1sgw, 1she, 1vjk, 1vk1, 1vka, 1vkc, 1xe1, 1xg9, 1xg7, 1xhc, 1xho, 1xi3, 1xi9, 1xk8, 1xkc, 1xma, 1xqu, 1xrg, 1xx7, 1y82, 1y81, 1yb3, 1ybx, 1yby, 1ybz, 1ycy, 1yd7). Of these, the following seven structures will be used in this example to demonstrate the capabilities of the pipeline: 1l7l, 1nnq, 1sl8, 1nnh, 1vjk and 1ryq. Included in these examples are two cases where experienced crystallographers failed to solve the structure using ‘rational’ values for program input parameters. The total time necessary to complete and refine the structure ranged from 4 h to one week depending on the resolution of the data.

1.b Materials, Experimental Conditions and Computational Methods.

1.b.(i). Pipeline Architecture

Protein and peptide electron density distributions and structures were determined using the Sca2Structure computational pipeline, which was designed and implemented on a Bioperl-pipeline based platform. A primary goal of the Sca2Structure computational pipeline is to efficiently and accurately determine crystal structures from scaled single-wavelength anomalous scattering or multi-wavelength anomalous diffraction X-ray diffraction data. The Sca2Structure computational pipeline integrates SOLVE/RESOLVE, ISAS, DM, SOLOMON, ARP/wARP and REFMAC analysis modules into a pipeline that spawns hundreds of jobs using various combinations of fixed and variable input parameters. An IBM 128 CPU Linux cluster was used for computing all protein and peptide crystal structures.

An integrated crystal determination system was employed for the present structure calculations comprising a dictionary-driven user interface, a work flow manager, and various output parsers. The integrated crystal determination system takes in scaled X-ray diffraction data at one end and outputs refined crystal structures at the other end. The integrated crystal determination system provides reasonable default parameters, their screening ranges and step sizes. In many cases, the default parameters worked very well for arriving at accurate electron density distributions and structures.

First, an internet web-based interface performs authentication of the usage of program pipelines, collects data and information to run pipelines, and initiates job tracking and monitoring. An internet web-based interface is beneficial because it is independent from the user operating system. Users can use the pipelines on any operating system including Windows, Unix or Macintosh platforms. Using an internet web-based interface also simplifies the pipeline usage for users avoiding the need for creating a special environment in which to run programs, or to install updates of the programs. This interface provides the flexibility to add or improve the backend pipeline programs and control the usage of the system without interrupting the usage of the pipelines.

In the present example, different pipelines may share the same authentication procedure, project management, job session tracking and monitoring functions. Once a user becomes familiar with the usage of one pipeline, he or she can easily use other pipelines. For the internet web page forms to collect necessary parameters to run pipeline, a dictionary-driven form generator was used, which is similar to the approach in the Brookhaven structure deposition tool AutoDep currently running at European Bioinformatics Institute. All the information needed to assist the user input the required information, such as parameter name, its description, the validation rules, and HTML representation information are specified in a dictionary. An input form may be generated from this dictionary. This approach gives the maximum flexibility in building new pipeline interfaces. A new pipeline input form can be easily built as long as the parameter dictionary items specified, and advantageously no programming is involved. In this way the new input is also easily adopted by the user since all the input forms may have same layout and design.

After the information has been submitted through the internet web interface, the information is transferred to the second layer of the pipeline building platform. This second layer uses workflow technology to manage the interaction of different software tools comprising analysis modules. Different crystallography software tools are wrapped into a modular form, and a configuration file specifies how these analysis modules are connected and what rules govern interactions between analysis modules. Building a new pipeline merely involves adding or rearranging these modules via manipulation of the configuration file. The configuration file is processed by a pipeline workflow manager which submits jobs to a 128 processor IBM Linux cluster. Bioperl-pipeline software handles running the programs specified by a given pipeline control file in the appropriate order. The Bioperl-pipeline software also ensures that computing resources are used as completely as is possible. The pipeline workflow system is adopted from Bioperl-pipeline, a flexible workflow system that has a wide range of job management facilities.

The third layer of the platform is the bioinformatics and crystallographic computational tools to analyze and visualize large amounts of output data from the pipelines, often comprising hundreds or thousands of output files. Output parsing algorithms and tools parse out key data items which are useful for interpreting the calculated crystal structures. The output data from discrete analysis modules and/or the computational pipeline are formatted into tabular form that can be easily sorted or filtered by the user. Tools and output-parsing algorithms are integrated into the internet web-based interface in a manner such that users can interact with them on the internet after their jobs are partially or completely processed. Preferably, data items are linked back to the original files from where they originated in case the user needs to refer to more details of the data. The generated structure file is normally in PDB format which can be directly viewed by Chime or other locally installed tools.

Finally, the platform uses a relational database to archive all the job process histories, input and output data as well as pipeline and input form dictionaries. A job can be rerun if necessary based on archived data. Archiving information in a database facilitates data mining of pipeline uses for future improvement.

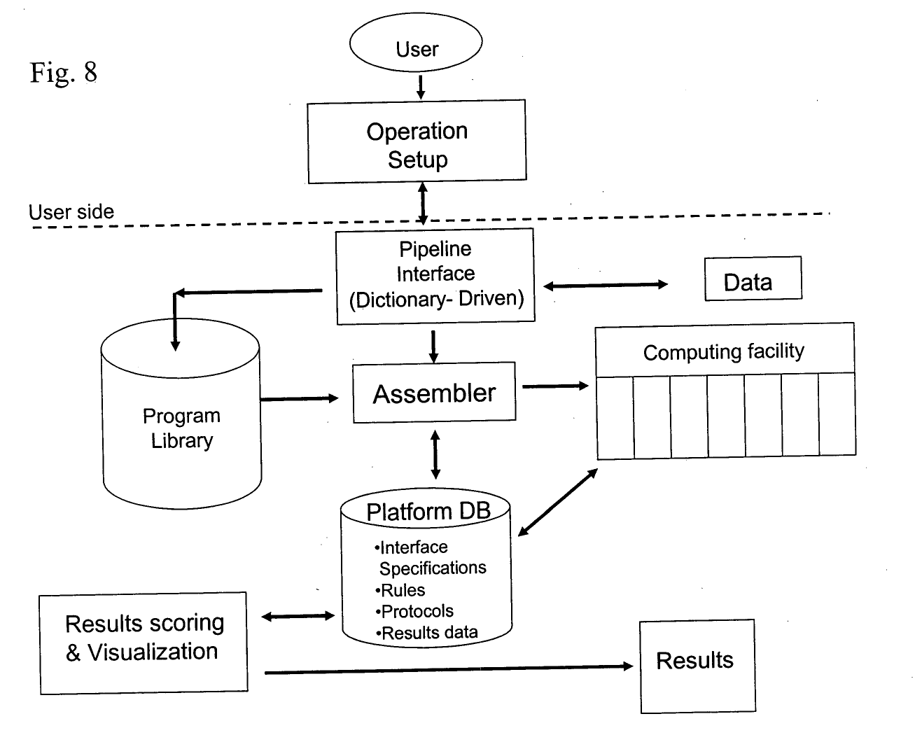

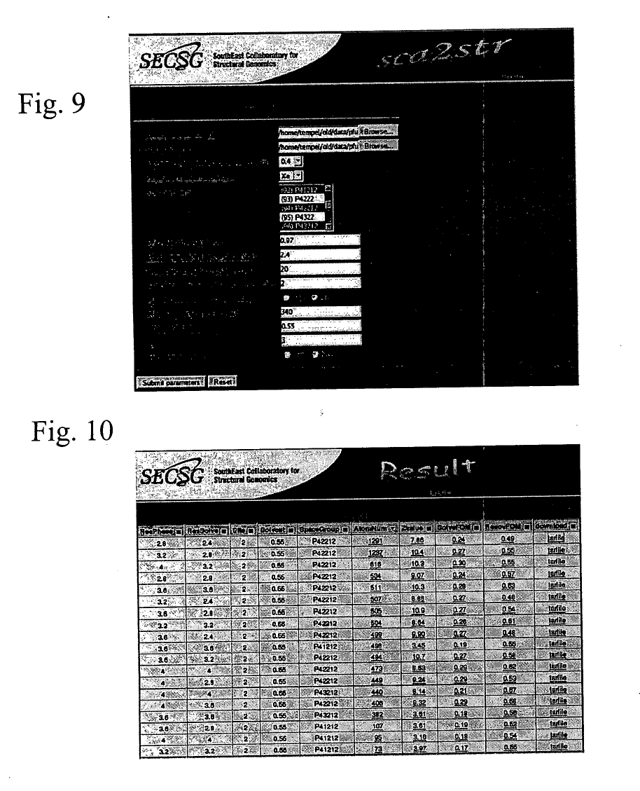

FIG. 8 provides a schematic diagram of a pipeline used in the present example comprising three major components: (i) a dictionary-driven web-based user interface, (ii) a BioPERL-based workflow-management system and (iii) a set of analytical tools for harvesting and visualizing data from the resultant log files. The web interface is used to authenticate users, upload experimental data and to input values for the various parameters (or parameter range) that will be used in the calculations. This networked client-server model has several advantages. Apart from the platform-independence of the client side, the crystallographic computing environment is administered centrally, relieving the user from tasks such as software installation and updates. It also allows the authentication procedure, project management, basic interface layout, session tracking and monitoring functions to be shared among different pipelines. Thus, once users become familiar with the usage of one pipeline, they can easily use other pipelines. FIG. 9 shows an exemplary web form used to collect the input parameters required to set up a structure-determination run is generated by a dictionary-driven form generator.

All information related to user input such as parameter name, parameter description, validation rules and HTML representation information are specified in a dictionary. With this dictionary based approach, the programming of interfaces for new pipelines is greatly facilitated since it only requires the addition of the appropriate entries to the dictionary. All information collected by the web interface is then transferred to the second layer of the pipeline platform, where workflow technology is used to manage the interaction of the different software tools. Based on this concept, the various crystallography software tools in the program library are converted to modules using the appropriate wrapper and a configuration file is used to specify how the various modules are connected and what input is to be used for each module. New pipelines are then assembled by the addition or rearrangement of these modules within the configuration file. The configuration file is processed by a BioPERL-based (http://www.bioperl.org) pipeline workflow manager that submits jobs to the cluster in the order specified by a given pipeline configuration file. The BioPERL workflow manager also ensures that computing resources are used as efficiently as possible.

Upon completion of the structure-determination run, a collection of analysis and visualization tools are used to harvest pertinent data from the numerous (typically between 500 to 1000) program log files generated by the structure determination run. The tools parse out key data items relevant to the crystallographer, which are formatted into web-based tables (e.g., the SCA2Structure report webpage). FIG. 10 shows an exemplary web-based table (the SCA2Structure report webpage) showing key data items that can be easily sorted and/or filtered by the user. In one embodiment, the following items are provided: (i) resolution values for phasing and phase extension/heavy-atom refinement, (ii) number of sites used in the search, (iii) solvent content used in the calculations, (iv) space group, (v) number of atoms traced by RESOLVE, (vi) SOLVE Z score, (vii) SOLVE figure of merit (FOM), (viii) RESOLVE FOM and (ix) a link to a tar file containing all output related to a given solution. A relational database is used to archive the job process history, input and output data and pipeline input form dictionaries. Using this approach, a job can be rerun if necessary based on archived data. In addition, the relational database format facilitates the mining of archived data. Based on the pipeline workflow platform described above, the SCA2Structure high throughput crystal structure determination pipeline is constructed. In its original implementation and for the purpose of actual structure solutions discussed herein, the SOLVE and RESOLVE programs provide a portion of the core crystallographic functionality. The capabilities of the present methods, however, have been extended over time by the integration of the programs ISAS, DM, ARP/wARP and REFMAC.

Based on its core components, the pipeline only requires the scaled reflection data (SCALEPACK or MTZ format), the polypeptide sequence and the expected solvent content of the crystal to produce an at least partial model of the peptide under investigation. With the addition of the ARP/wARP module, for example, the pipeline has produced, in the case of PA-L1, a nearly complete refined model of the protein. In one embodiment, the SCA2Structure pipeline user interface provides reasonable default parameters (or screening range) including step size for inexperienced users. It has been our experience that the default parameters work very well in most cases. In its current implementation, SCA2Structure permits screening of the following.

(i) The number of expected heavy-atom (or anomalous scatterer) sites (SOLVE).

(ii) Space groups.

(iii) High-resolution data cutoff for the heavy-atom search (SOLVE).

(iv) High-resolution data cutoff for initial phasing (SOLVE/ISAS).

(v) High-resolution data cutoff for phase improvement/extension (RESOLVE).

(vi) Phasing programs (SOLVE/ISAS).

1.b.(ii) Protein Samples

The protein samples used in the analyses were expressed and purified according to published procedures. The Pseudomonas aeruginosa lectin-1 (PA-L1) sample was prepared according to the procedure described in Karaveg, K., Liu, Z. J., Tempel, W., Doyle, R. J., Rose, J. P. & Wang, B.-C. (2003). Acta Cryst. D59, 1241-1242. The P. furiosus samples (Pfu-263306, Pfu-562899, Pfu-1210814 and Pfu-1801964) were prepared by the SECSG P. furiosus Protein Production Core following a general procedure described in Adams, M. W., Dailey, H. A., DeLucas, L. J., Luo, M., Prestegard, J. H., Rose, J. P. & Wang, B.-C. (2003). Acc. Chem. Res. 36, 191-198, and using the genes encoding the respective proteins. The Clostridium perfringens GlcNAc_{—}1-4 Gal-releasing endo-β-galactosidase (Endo-β-Gal) sample was prepared according to the method as described in Ashida, H., Maskos, K., Li, S. C. & Li, Y. T. (2002). Biochemistry, 41, 2388-2395.

1b.(iii). Crystallization

With the exception of PA-L1, all crystals were obtained by the microbatch-under-oil method (D'Arcy et al., 2003) using a modified Douglas Instruments ORYX 6 robot (Shah et al., 2005) and 72-well Nunc plates. The crystallization drops contain 0.5 ml protein solution mixed with 0.5 ml precipitate solution. The drops were covered with a 7:3(v:v) layer of paraffin and silicon oils. The crystallization experiments are summarized in Table 2.

TABLE 2
Crystallization results.

| Protein | Crystallization condition | Derivatization |
|---|---|---|
| PA-L1 | See, Karaveg, K., Liu, Z. J., | |
| | Tempel, W., Doyle, R. J., Rose, | |
| | J. P. & Wang, B.-C. (2003). | |
| | Acta Cryst. D59, 1241-1242. | |
| Pfu-1210814 | | |
| Ca-aequorin | 100 mM sodium acetate pH 4.6, | |
| | 30%(v/v) 2-methyl-2,4- | |
| | pentanediol and 0.02 M calcium | |
| | chloride, incubated at 277 K | |
| Pfu-1801964 | 100 mM sodium citrate pH 5.9, | 100 mM sodium citrate pH 5.9, |
| | 10%(w/v) PEG 3000 and 500 mM | 10%(w/v) PEG 3000 and 500 mM |
| | magnesium chloride, | magnesium chloride, |
| | incubated at 291 K | incubated at 291 K |
| Endo-β-Gal_{GnGa} | See, Deng, L., Liu, Z. J., | |
| | Ashida, H., Li, S. C., Li, Y. T., | |
| | Horanyi, P., Tempel, W., Rose, | |
| | J. & Wang, B.-C. (2004). Acta | |
| | Cryst. D60, 537-538. | |
| Pfu-562899 | Native crystal: 100 mM sodium | Addition of small grain of |
| | cacodylate pH 6.5, 30%(w/v) | potassium iodide to the drop |
| | PEG 8000 and 200 mM | and |
| | ammonium sulfate, incubated at | soaking for 4 h |
| | 291 K. | |
| | Derivative crystal: 100 mM Tris | |
| | pH 7.0, 2 M ammonium sulfate | |
| | and 200 mM lithium sulfate, | |
| | incubated at 291 K | |
| Pfu-263306 | 100 mM sodium citrate pH 6.6 | Addition of small grain of |
| | and 25%(w/v) PEG 3000, | potassium iodide to the drop |
| | incubated at 291 K | and soaking for 4 h |

1.b.(iv). X-Ray Diffraction and Data Reduction

For data collection, the crystals were mounted in nylon loops, flash-cooled in liquid nitrogen, mounted on the goniometer and maintained at 100 K in a nitrogen-gas cryostream. The data collection and processing was optimized for single-wavelength anomalous scattering phasing. Details of the data collection for the various samples are given in Table 3. Data were indexed, integrated and scaled using the HKL (DENZO/SCALEPACK) suite (Otwinowski & Minor, 1997) in all cases with the exception of Pfu-263306 and Pfu-1801964, where the PROTEUM package (Bruker AXS) was used for data processing (see Table 3).

TABLE 3
Data-collection and data-processing results.
(Values in parentheses were observed in the high-resolution shell.)

| | | Pfu- | Ca- | Pfu- | Endo-β- | Pfu- | Pfu- |
|---|---|---|---|---|---|---|---|
| Protein | PA-L1 | 1210814 | aequorin | 1801964 | Gal_{GnGa} | 562899 | 263306 |
| Molecular | 12.9 | 19.5 | 22.5 | 34.0 | 49.4 | 10.3 | 6.95 |
| weight (kDa) | | | | | | | |
| X-ray source | Cu | SER- | Cr anode | Cu anode | SER- | SER- | Cu |
| | anode | CAT* | | | CAT* | CAT* | anode |
| Wavelength | 1.54 | 0.97 | 2.29 | 1.54 | 1.70 | 2.00 | 1.54 |
| (Å) | | | | | | | |
| Detector | R-AXIS | MAR | R-AXIS | Smart | MAR | MAR | Smart |
| | IV | CCD165 | IV | 6000 | CCD165 | CCD225 | 6000 |
| Exposure (s) | 300 | 20 | 420 | 60 | 5 | 3 | 60 |
| Oscillation | 360 × 0.5 | 2 × 200 × 0.5 | 202 × 1.0 | 2 × 350 × 0.3 | 6 × 160 × 0.5 | 360 × 1.0 | 2 × 400 × 0.3 |
| range (( ) | | | | | | | |
| Distance | 150 | 170 | 126.2 | 90 | 110 | 80 | 60 |
| (mm) | | | | | | | |
| Space group | I222 | P4₂2₁2 | P4₃2₁2 | I4₁ | P6₃ | P6₅22 | P3₂21 |
| Unit-cell | | | | | | | |
| parameters | | | | | | | |
| a (Å) | 40.25 | 105.92 | 54.34 | 68.36 | 159.53 | 81.35 | 45.66 |
| b (Å) | 72.30 | 105.92 | 54.34 | 68.36 | 159.53 | 81.35 | 45.66 |
| c (Å) | 133.82 | 81.00 | 135.06 | 151.64 | 85.85 | 63.55 | 50.78 |
| High- | 1.86-1.80 | 2.43-2.35 | 2.59-2.50 | 2.29-2.10 | 2.78-2.6 | 82.38-2.30 | 1.96-1.80 |
| resolution | | | | | | | |
| shell (Å) | | | | | | | |
| Completeness | 93.7 | 99.9 | 99.5 | 83.3 | 98.0 | 99.9 | 87.5 |
| (%) | (57.9) | (100.0) | (95.4) | (44.9) | (80.0) | (100.0) | (50.5) |
| Rsym (%) | 3.5 | 7.1 | 7.0 | 3.8 | 6.9 | 8.9 | 3.6 |
| | (9.1) | (36.9) | (12.9) | (9.3) | (33.3) | (12.1) | (6.7) |
| I/_(I) | 44.8 | 36.7 | 34.1 | 14.5 | 55.7 | 78.9 | 16.4 |
| | (11.1) | (6.3) | (11.0) | (5.0) | (7.2) | (49.7) | (4.9) |

*SER-CAT: Southeast Regional Collaborative Access Team, Sector 22, Advanced Photon Source, Argonne National Laboratory.

1.b.(v). Computing Hardware and Software

Calculations were carried out on a 64-node cluster of two-way servers (International Business Machines) based on the ×86 architecture. Resource management and job scheduling were handled by a combination of the OpenPBS (http://www.openpbs.org) and MAUI (http://www.supercluster.org/maui) packages. Job preparation and tracking was based on the BioPERL (http://www.bioperl.org) suite. Web content for job submission and result retrieval was served by the Apache (http://httpd.apache.org) HTTP server.

1.b.(vi). Structure Solution, Phase Improvement, Chain Tracing and Refinement

The anomalous substructure and initial phases were determined using SOLVE (Terwilliger & Berendzen, 1999) in SAS mode. Phase refinement was carried out using RESOLVE (Terwilliger, 1999). Resolution cutoffs for initial phasing and phase extension were screened within the limits shown in Table 4. As shown, in some instances calculations were performed for several candidate space groups and oligomeric states. For all structures described here, calculations involving SOLVE and RESOLVE were performed on the high throughput pipeline platform. In the case of PA-L1, the pipeline was extended to also run ARP/wARP.

TABLE 4
Parameters screened by SCA2Structure pipeline.

| | | Pfu- | Ca- | Pfu- | Endo-β- | Pfu- | Pfu- |
|---|---|---|---|---|---|---|---|
| Protein | PA-L1 | 1210814 | aequorin | 1801964 | Gal_{GnGa} | 562899 | 263306 |
| Resolution | 3.4-2.0 | 4.0-2.4 | 3.8-2.6 | 3.8-2.2 | 3.8-2.9 | 4-2.4 | 3.6-2.0 |
| range | | | | | | | |
| screened | | | | | | | |
| Increment (Å) | 0.2 | 0.4 | 0.3 | 0.2 | 0.3 | 0.2 | 0.2 |
| Optimal | 2.0 | 2.8 | 2.6 | 2.4 | 3.2 | 2.6 | 2.0 |
| resolution for | | | | | | | |
| initial | | | | | | | |
| phasing (Å) | | | | | | | |
| Optimal | 1.8 | 2.4 | 2.5 | 2.2 | 2.7 | 2.5 | 2.0 |
| resolution for | | | | | | | |
| phase | | | | | | | |
| extension (Å) | | | | | | | |
| No. heavy- | 4/4 | 2/2 | 9/10 | 2/2 | 17/20 | 4/4 | 1/4 |
| atoms | | | | | | | |
| found/sought | | | | | | | |
| Solvent | 0.65 | 0.55 | 0.46 | 0.52 | 0.44/0.62 | 0.55 | 0.43 |
| content used | | | | | | | |
| in phase | | | | | | | |
| extension | | | | | | | |
| Space group | I222 | P4₂2₁2 | P4₃2₁2, | I4₁ | P6₃ | P6₅22, | P3₂21, |
| | | | P4₁2₁2, | | | P6₁22 | P3₁21 |
| | | | P4₂2₁2 | | | | |
| Total No. jobs | 55 | 180 | 180 | 72 | 80 | 56 | 90 |
| Total time | 1 h | 5 h | 2 h | 2 h | 5 h | 33 min | 32 min |

1.c. Structure Determination Using Sca2Structure Pipeline.

The ability of the present methods to efficiently determine accurate electron density distributions and crystal structures was verified. The crystals were flash-cooled to 100K, and X-ray diffraction data collection was carried out under liquid N₂ flash-cooled condition. The data collection and processing were optimized for single wavelength anomalous scattering phasing. Tables 3, 4 and 5 lists the parameters screened by the SCA2Structure pipeline for the examples described below, including the number of jobs spawned by the pipeline and the amount of time it took to produce a structure using the pipeline.

1.c.(i). 2.1 Pa-1 Lectin (a Galactophilic Lectin From Pseudomonas Aeruginosa)

Pa-1 lectin, a 12.9 KDa galactophilic lectin from Pseudomonas aeruginosa, was the first structure solved using the Sca2Structure pipeline. The protein contains 1 calcium ion and 3 ordered sulfur-containing amino acid residues (2 cysteine and 1 ordered methionine). 360 degrees of data were collected using Raxis-IV detector on a Rigaku FRD X-ray generator with MaxScreen optics with Cu-Kα radiation.

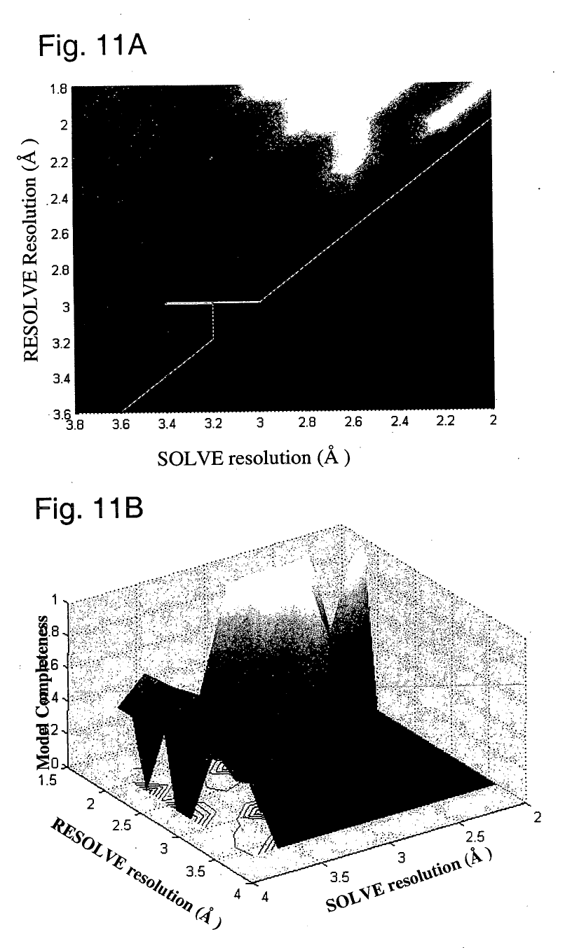

Initial attempts to solve the structure using SAS data collected in house and analysed with SOLVE did not produce an interpretable electron-density map. The first model of this protein (PDB code 1l7l) was instead based on synchrotron data. The in-house data set was revisited during the initial tests of the SCA2Structure pipeline. The pipeline was able to solve the PA-L1 structure using in-house data giving a complete (98%) ARP/wARP trace. However, as one would expect, not all parameter combinations generated by the pipeline led to a successful structure determination. FIGS. 11A and 11B provide graphical representations of pipeline success space for the PA-L1 example. A total of 55 SOLVE/RESOLVE phase sets were used as input to ARP/wARP. The gray scale scheme used represents success (number of residues fitted), with light regions indicating a near-complete model and dark regions representing cases where model building failed. An interesting and unexpected feature is that success space is not continuous with regions of low success sandwiched between regions of high success.

One surprising outcome of this study was that success using two values for a resolution cutoff did not guarantee success with an intermediate value. This is illustrated in FIGS. 11A and 11B, which shows that when a high-resolution cutoff of 2.0 Å was used for both SOLVE and RESOLVE, the pipeline failed to produce a structure. However, when the RESOLVE resolution cutoff is either 1.8 or 2.2 Å a solution is obtained. Analysis of the anomalous scattering substructures for these three cases reveals that for the unsuccessful case SOLVE produced the enantiomer of the correct anomalous substructure, resulting in an uninterpretable electron-density map. Phase extension and model building were automatically performed with the program ARP/wARP within the pipeline platform. The final refinement was carried out with REFMAC within CCP4.

1.c.(ii) Pfu-1210814 (Rubrerythrin)

Pfu-1210814 is a 20.4 KDa recombinant protein from Pyrococcus furiosus. The sequence of Pfu-1210814 exhibits Fe metal binding motifs, thus, the X-ray diffraction data were collected at a wavelength of 1.74 Å. This was the first ‘unknown’ pipeline SAS test structure. P. furiosus rubrerythrin, similar to its known homologues, contains iron-binding motifs and an experiment was designed to exploit the iron anomalous scattering signal by recording phasing data using 1.74 Å X-rays. A second set of data was recorded to higher resolution using 0.97 Å X-rays for refinement purposes. Both data sets were processed keeping Bijvoet-related reflections separate. When the pipeline failed to produce a structure using the phasing data, the high-resolution data set was subjected to the same analysis. To our surprise, the pipeline produced a structure (80% complete RESOLVE) from this data set. The RESOLVE phases and initial trace were then used to manually complete the model with XFIT (McRee, 1999). The final refinement was carried out with REFMAC within CCP4. The coordinates have been deposited in the PDB (entry 1nnq). The structure revealed that zinc has replaced iron in the iron binding site, which explains why the phasing data failed to produce a structure. By chance, the high-resolution data were collected using a wavelength where the zinc anomalous scattering signal, although not optimal, was sufficient to solve the structure. In addition, since the space group could only be unambiguously assigned once the structure had been solved, the pipeline setup included the screening of several candidate space groups.

Resolution screening for solve was completed first for initial phasing. By default, the screening starts from 4.0 Å. The users assigned the high resolution cutoff. The screening was done from 4.0 Å to that cutoff. For example, where the high resolution cutoff is 2.4 Å (the number shows on the axis of solve) and increment is 0.4 Å, the screening is done for initial phasing at resolution at 4.0 Å, 3.6 Å, 3.2 Å, 2.8 Å, 2.4 Å, respectively. Similarly, users provided a high resolution cutoff for Resolve, which is used to perform phase refinement and extension. The screen range starts from the resolution used by Solve to the resolve high resolution cutoff by a specified increment. This is because in Resolve step, it incorporates more experimental information than that in the initial phasing, so the resolution should be no worse than the resolution at initial phasing. An example is that if solve use 3.6 Å for initial phasing, the Resolve screening increment is 0.4 and the high resolution cutoff is 2.4, the Resolve screens at 3.6 Å, 3.2 Å, 2.8 Å, 2.4 Å respectively. The refinement to 2.35 Å is nearly complete with an Rᵥₐₗᵤₑ of 0.222 (R_{free} =0.258).

The complete screening combination is provided by:

```
For (I starts at 4.0, until <= 2.4, increment by 0.4) # solve;
    For (J start I, until <= 2.4, increment by 0.4) # resolve
        Test solve(I) and resolve(J) combination;
    End For J loop;
End For I loop.
```

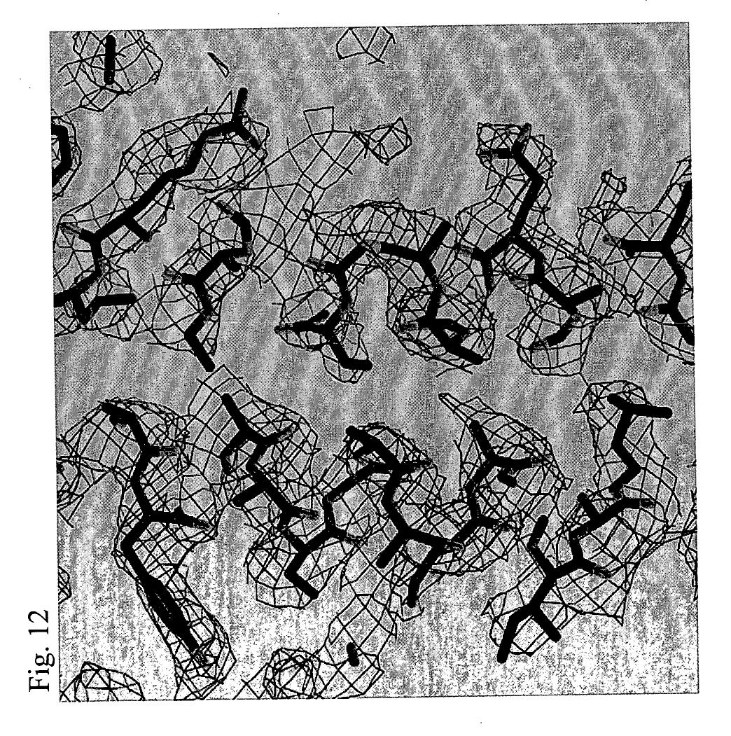

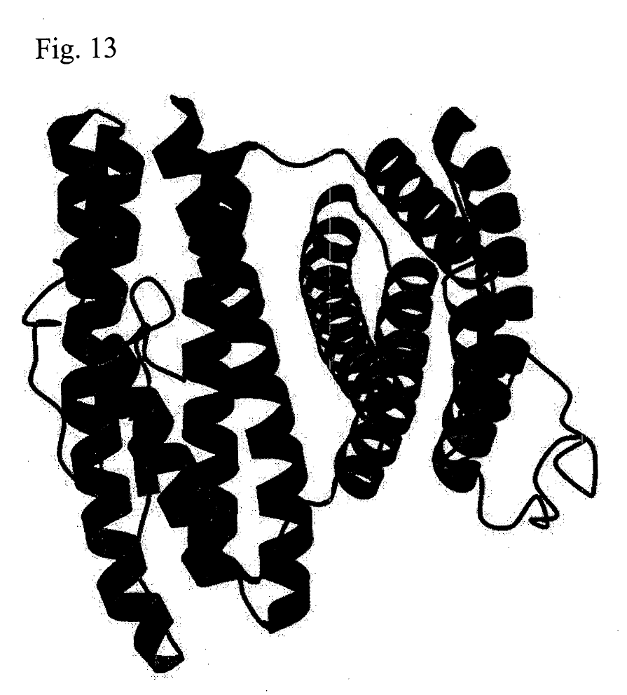

FIG. 12 shows a superposition of the experimentally determined map with an auto traced model for Pfu-1210814. Domain swapping was found by comparison with D. vulgaris rubrerythrin (PDB entry 1DVB), which shows a 32% sequence identity (PSI-Blast score 1e-15) to Pfu-1210814. FIG. 13 shows the structure of the Pfu-1210814 homodimer illustrating the domain swapping discovered within the dimer structure. As shown in FIG. 13, the domain swapping dimer structural motifs are formed by interaction of the peptide chain of a first Pfu-1210814 with the peptide chain of a second Pfu-1210814 and by interaction of the peptide chain of the second Pfu-1210814 with the peptide chain of the first Pfu-1210814.

1.c.(iii) Pfu-1801964 (a Putative Asparaginyl-tRNA Synthetase From P. Furiosus)

Pfu-1801964 is a recombinantly produced protein from Pyrococcus furiosus. The crystal was soaked with K₂PtCl₄ and the data was collected using Smart 6000 CCD detector on a Rigaku FRD X-ray generator with MaxScreen optics with Cu—Kα radiation. The methods of the present invention were used to determine the structure of Pfu-1801964.

The structure was solved by the pipeline from a single set of SAS data collected on a K₂PtCl₄ derivative of the protein using Cu Kα X-rays. The RESOLVE peptide trace produced by the pipeline was manually completed using XFIT. The resulting model was then used to generate molecular-replacement (EPMR; Kissinger et al., 1999) phases for a higher resolution data set followed by automated rebuilding (ARP/wARP). The final refinement was carried out with REFMAC in CCP4.

1.c.(iv) Ca-Aequorin (a Calcium-Sensitive Photoprotein From Aequorea Aequorea)

Aequorin is a calcium-sensitive photoprotein naturally obtained from the jellyfish Aequorea. The structure used in this study is the calcium discharged aequorin, which is believed to bind three calcium ions. Several diffraction data sets from different native crystals were collected using a chromium X-ray source. The methods of the present invention were used to determine the structure of Ca-Aequorin.

A single data set was collected on a crystal of calcium-loaded Ca-aequorin using Cr Kα X-rays (α=2.909 Å). The pipeline produced a structure based on three calcium ions and eight S atoms determined by SOLVE. Again, three space groups were analyzed by the pipeline during the structure determination. The RESOLVE phases and initial trace were then used to manually complete the model with XFIT. The final refinement was carried out with REFMAC in CCP4.

1.c.(v) Endo-β-Gal (GlcNAcα1-4Gal-Releasing Endo-β-Galactosidase From Clostridium Perfringens).

The structure was solved using data collected on an iodide derivative (iodide quick soak; See, Dauter, Z., Dauter, M. & Rajashankar, K. R. (2000). Acta Cryst. D56,232-237) of the protein recorded using 1.74 Å X-rays. The phases from RESOLVE and the RESOLVE trace were used to manually complete the model with XFIT. The final refinement was carried with REFMAC in CCP4. The coordinates have been deposited in the PDB (entry 1 ups).

1.c.(vi). Pfu-562899 (Molybdopterin-Converting Factorsubunit 1 From P. Furiosus).

The structure was solved using the pipeline from data collected from a halide derivative (See, Dauter, Z., Dauter, M. & Rajashankar, K. R. (2000). Acta Cryst. D56,232-237) crystal. Phases from RESOLVE were used for automated model building in ARP/wARP. The model was refined (REFMAC) against an isomorphous higher resolution data set.

1.c.(vii). Pfu-263306 (a Putative DNA-Directed RNA Polymerase Subunit “00).

In this case, the enantiomorphic space group ambiguity (P3121 or P3221) had to be resolved as part of the structure-determination process. The structure was solved using data collected from an iodide derivative. Phases from RESOLVE were used for automated model building in ARP/wARP. The model was refined (REFMAC) against a set of isomorphous higher resolution data. The resulting model revealed a zinc-sulfur site involving four cysteinyl residues. Interestingly, electron density also defined some residues of the N-terminal histidine purification tag.

1.c.(viii) Human Protein Q1569

The methods of the present invention can be used to determine the structure of peptide Q15691, which is a 14.3 kDa fragment of a human protein. Peptide Q15691 has 6 sulfur containing residues (2 cysteines and 4 methionines). Sulfur's single wavelength anomalous scattering (S-SAS) phasing method was chosen to solve this structure and the results are shown in Table 5. The anomalous diffraction data were collected on the Raxis-IV detector using chromium X-ray source. The processed data were input into the Sca2Structure pipeline and 162 out of 260 residues of the homodimer were traced automatically at the end of the run. All the sulfur sites were located by SOLVE. The electronic density has excellent quality which enables easy manual tracing.

TABLE 5
Data collection and data processing results

| | | |
|---|---|---|
| Protein | Q-15691 | LEN |
| X-ray Source | Cr-Kα | Cu-Kα |
| X-ray Optics | | |
| Wavelength(Å) | 2.29 | 2.29 |
| Detector | Raxis-IV | Raxis-IV |
| Exposure Time (seconds) | 300 | 240 |
| Oscillation Range(°) | 1.0 | 1.0 |
| Distance (mm) | 126.2 | 126.2 |
| Data Processing Program | HKL2000 | Denzo 1.97 |
| Space Group | P212121 | P4222 |
| Cell Parameter | 58.32 | 65.41 |
| | 61.18 | 65.41 |
| | 67.51 | 51.69 |
| Resolution(Å) | | |
| Completeness(%) | | |
| Bijvoet Redundancy | | |
| R_{merge} (%) | | |

1.d. Interpreting Results

Because of the distributed nature of the pipeline, hundreds of log files can be generated in a typical structure-determination run. Analyzing this vast amount of data manually would be a formidable task, so a set of analytical tools for extracting and visualizing the results in an organized manner via the pipeline Result webpage (see e.g. FIG. 10) has been developed. In our experience, sorting the data based on the number of residues fitted by RESOLVE gives the best indication of a successful structure determination. Generally, a solution will have the greatest number of atoms fit by RESOLVE, providing that the resolution used for the phasing (SOLVE) and phase-extension (RESOLVE) calculations are high. Additionally, a correct solution will have a high SOLVE Z score and SOLVE FOM. Using the above criteria, tar files for the potential solutions are downloaded from the pipeline Result page to the client computer where the experimental electron-density maps can be inspected manually to confirm the solution.

Experience has shown that screening for the number of heavy-atom sites to be found did not produce better results than when a single slightly overestimated value for this parameter was used in the calculations since SOLVE automatically rejects doubtful heavy-atom sites. However, as noted above in the case of PA-L1, a variation of the resolution cutoffs produced interesting and non-intuitive results (See, e.g., FIGS. 11A and 11B). In this case, the resolution ranges that resulted in successful automated model building were not continuous and imply that structure-determination failure may be the result of the inopportune choice of resolution cutoffs for SOLVE and RESOLVE even when the data were capable of providing a solution using different resolution cutoffs. The addition of higher resolution data into calculations also does not always guarantee success. This is because although the observation to parameter ratio is increased owing to the added data, the anomalous differences, which are increasingly weak at high resolution, decrease the signal-to-noise ratio in the data. As indicated in the above examples, the ARP/wARP module of the pipeline is typically not used in the structure determination process but is run independently after a successful solution is found. This is because crystallographers usually separate data collection for phasing purposes from data collection to be used for high-resolution refinement. This approach allows for the optimization of the anomalous signal in the phasing data and for the optimization the intensities of the weak reflections at high resolution in the refinement data. In addition, running ARP/wARP in every case would waste considerable CPU time since only a few of the pipeline jobs submitted will produce useful phases. Instead, the results from the SOLVE/RESOLVE runs are first analyzed and if a successful solution is found and the resolution of the data permits ARP/wARP is run (usually on a higher resolution data set or a data set collected at a higher energy which should have lower absorption effects).

1.e. Conclusions

The SCA2structure pipeline has become the primary method of de novo structure solution and has been instrumental in the determination of over 40 structures. The simple job-submission webpage coupled with a fine sampling of program parameter space can help to answer several of the questions posed in Section a. These include (i) are the data of sufficient quality to permit solution of the structure, (ii) are more data needed and (iii) what are the optimal values for the input parameters for the programs used in the structure-determination process? Crystallographers have used the pipeline for on-site structure determination at the beamline to answer these questions. Typically, once data are collected and processed at the beamline, a structure-determination run is submitted to the UGA cluster via the pipeline job-submission web page. The crystallographer is then free to begin data collection on the next target on the list. Once the structure determination jobs have finished (usually between 1 and 2 h), the results can be quickly analyzed (using the pipeline Web Report page) to determine whether more data are needed to solve the structure. This approach has proven to be quite efficient and in one recent case five structures were solved in a 23 h period by crystallographers on-site at SER-CAT

The success of the pipeline is based on several factors. (i) By parameter-space screening, the SCA2Structure pipeline dramatically increases the structure-solution success rate. This in turn decreases the number of trials required and thus reduces the time needed for structure determination. (ii) The web-based user interface allows easy job submission and result retrieval since it can be accessed from any location including the synchrotron beamline. (iii) Its ease of use and a 128-processor cluster make the pipeline an almost real-time tool for the analysis of data quality (capability to produce a SAS structure) and structure production. (iv) The dictionary driven design and facile extensibility of the platform permit easy adoption of new pipeline modules and/or alternative computational protocols while maintaining a consistent user interface layout.

The power of the pipeline comes from the parameter-space screening. This innovation overcomes the peculiarities associated with a given data set arising from crystal quality, experimental errors and other factors that make each data set a unique case; optimal values can be quickly found that are best suited for a given data set. Since the user only needs to supply the parameter range and sampling step to be used, the process becomes very efficient. The current pipeline runs on a 128-processor Linux cluster. However, the BioPerl job-management system allows easy configuration to any system including a single processor. The efficiency of the process is however dramatically reduced as the number of processors decreases.

The SCA2Structure pipeline provides a powerful tool for SAS phasing problems. It has fundamentally changed the way in which a structure determination is carried out. The discovery of trends not only influences the development of pipelines functionality but also influences general aspects of crystallographic structure determination. For example, pipelines such as the SAS pipeline discussed here provide a convenient quality-assessment tool for diffraction data. Because the pipeline produces structure solutions for some data sets while it fails to find answers with others, it is possible to identify characteristics that may act as predictors for success or failure. Because some of these characteristics are directly affected by experimental procedures, once decisive factors have been identified data collection procedures the identification of decisive factors will allow rational adjustment of data-collection design and/or parameters to increase the probability of success.

### EXAMPLE 2

### Determining Protein Crystal Structures Using Molecular Replacement Techniques

The methods of the present invention were also used to determine electron density distributions and crystal structures of proteins using phase information derived from reference structures. The results of these studies indicate that the present methods increase the success rate of structure solving by taking advantage of parallel structure calculations using modular computational pipelines which explore a much larger parameter space than is searched using conventional crystallographic methods.

The structure of Pfu-1862794, a 28.8 KDa recombinant protein from Pyrococcus furiosus, was determined using the AMOREpipe computational pipeline. This pipeline comprised a plurality of analysis modules capable of calculating electron density distributions and crystal structures using molecular replacement methods, and was designed and implemented on a Bioperl pipeline based platform. X-ray diffraction data for these calculations was collected to 2.4 Å using 0.97 Å X-rays at SER-CAT.

A sequence search by bioinformatics computational tools showed that Pfu-1862794 has 49% homology with Mj0109 Gene from Methanococcus jannachii, which function is annotated as Inositol Monophosphatase-Fructose 1,6 Bisphosphatase (PDB code: 1G0l). The processed diffraction data and the model molecule 1 G0l were submitted to the AMOREpipe computational pipeline through a Web interface. It took a crystallographer 5 minutes to initiate the AMORE runs. Variable input parameters screened in the calculation included the high resolution limit which ranged from 2.5 Å to 5.0 Å with a screen increment equal to 0.2 Å and the integration radius for rotation calculation which ranged from 55% to 75% of the longest dimension of the unit cell with a screen increment of 5%. In addition, all the top ten rotation solutions were used for further translation calculations. At the end of the AMOREpipe runs, an initial R-factor of 48.6% at 3.0 Å resolution was obtained. This value of the R-factor indicates good agreement between the calculated structure and the diffraction data.

In another example of the present methods using the AMOREpipe computation pipeline, the results of molecular replacement crystal structure solutions for cardiotoxin were compared to crystal structure solutions generated by CCP4 for cardiotoxin. The initial solution produced by AMOREpipe (R-factor 42%) was better than the solution produced by CCP4 (R-factor 45%). The better structure determined using the methods of the present invention is due to the substantially larger parameter space searched using the AMOREpipe computational pipeline.

### EXAMPLE 3

### High-Throughput Protein-to-Structure Pipeline

The present methods provide a high-throughput platform for determining structures and electron density distribution or biomolecules. The present methods are accurate, versatile and compatible with automation Therefore, high-throughput methods of the present invention provide a particularly attractive and robust route for determining a wide range structures, such as protein and peptide structures, that is capable of effective scale-up.

3.a. Introduction

A high throughput protein-to-structure pipeline has been developed by the crystallography core. It integrates robotics and other automation technologies into three modules that interact closely: crystallization, crystallomics (target salvaging) and structure determination/ validation. Relational databases provide the backend for communication between these relatively independent modules. While extensive experience with the pipeline confirm the significance of automation, we are also aware of the importance of data management. The multiplicity of samples and the large amount of data associated with a high-throughput operation extend the challenge beyond a simple scale-up of traditional laboratory practices. More planning, testing and fine-tuning and a more complex approach to project management are an absolute requirement. Success in this environment relies heavily on the integration not only of hardware and software, but also of the various pipeline stages.

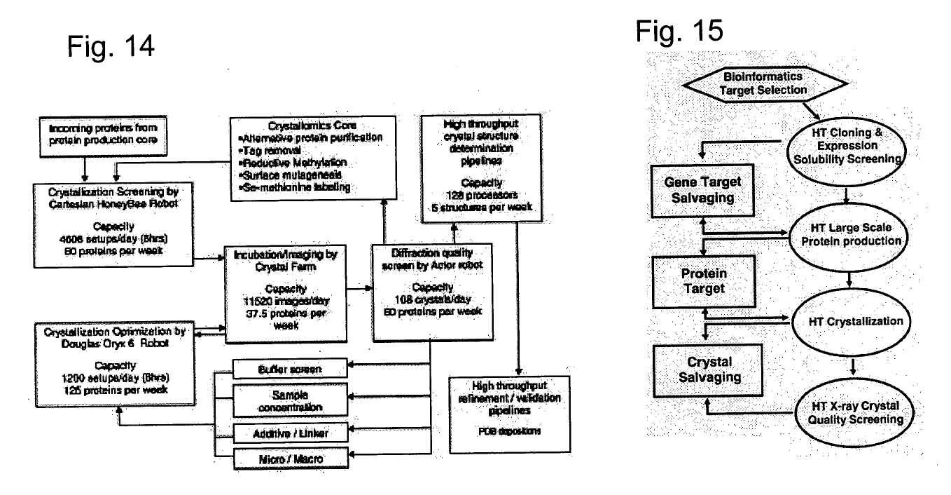

At this point in time, structural genomics still suffers from the relatively high cost and low success rate in going from purified protein samples to structures. In high-throughput mode, each protein target receives an equal amount of attention and consequently easier targets (‘low-hanging fruit’) will be solved while the more difficult ones will generally be abandoned before they yield a structure. Based on the current statistics of the nine NIH PSI centers, on average only 13% of purified protein samples resulted in a successful structure determination. Therefore, 87% of the purified samples are abandoned before a structure is obtained. In order to balance the throughput and the success rate of the structure-determination process, an alternate path (crystallomics) for rescuing these failed targets was implemented providing a two-tiered approach for protein production. In the first tier protein-production activities are focused on producing all proteins (both low-hanging and high hanging fruit) from the P. furiosus and C. elegans genomes using high-throughput methods and selected MGC human proteins using more traditional methods. In the second tier, protein production efforts support tier 1 production activities. In that role, the crystallomics group provides scaled-up amounts of tier 1 protein repeats for further crystallization trials, where necessary, and prepares labeled and otherwise modified proteins for crystal optimization and structure-determination purposes. Here, we describe briefly the protein to structure pipeline developed including procedures of crystallization, crystal diffraction characterization, data collection/processing, structure refinement/validation and data management. FIG. 14 provides a schematic diagram of a high-throughput protein-to-structure pipeline of the present invention.

3.b. Materials and Methods

3.b.(i). Crystallization

When protein samples become available for crystallization trials, the protein-production group responsible for the protein notifies the crystallization group via the ExpressSG database. A product sheet listing all relevant information about the protein, including sequence, predicted isoelectric point, concentration, buffer, metal content and the scanned image of an SDS-PAGE gel, accompanies each sample. The product information is also made available on the web (http://www.secsg.org/cgi-bin/report.pl). Prior to screening, protein samples are assigned a barcode ID and again checked for purity by both PAGE and dynamic light scattering. Each sample is screened against 384 reagent mixtures made up from seven commercial sparse-matrix screens: Crystal Screen, MemFac, PEG Ion, Crystal Screen Cryo, Crystal Screen II (Hampton Research), Wizard I and II (Dedode Genetics) and the locally developed MP1 screen containing 48 conditions (Shah et al., 2005). Condition Nos. 25 and 27 were removed from Crystal Screen I and Crystal Screen Cryo because they have had the lowest success rate in crystallizing proteins in the past and thus were omitted from the screens. Initial screening is carried out by the sitting-drop vapor-diffusion process using Greiner Crystalquick plates set up with a Cartesian Honeybee crystallization robot (Genomic Solutions). Drop compositions consist of 200 nl protein solution plus 200 nl reservoir solution, giving a total drop volume of 400 nl.

Once a plate has been bar-coded and set up, it is moved to the CrystalFarm incubator (Discovery Partners International) for storage, imaging and scoring. Crystals are scored as follows: (1) clear, (2) precipitate, (3) crystal and (4) harvestable. Images and scores are currently recorded in the CrystalFarm database and transferred to the Crystal Monitor (Decode Genetics) database application. Crystal hits are optimized by the modified microbatch method using a single or double grid-screen approach around the selected condition. The optimization is performed using locally modified Douglas Instruments ORYX robots using 1 ml drops containing equal volumes of protein and precipitant solutions (Shah et al., 2004) on a 72-well Nunc plate (Nalge Nunc International). A Genesis RSP robot (Tecan) is used to reformat the commercial screens for the initial trials and to prepare grid screens for optimization.

3.b.(ii). Crystallomics and Target Salvaging

Several techniques are applied, some in combination, to salvage protein targets that fail to produce well diffracting crystals. In the case of overexpression of recombinant hyperthermophile proteins, the cell lysate may undergo heat treatment at 343 K for 1 h to precipitate contaminants. In a modification of the standard purification procedure for oligohistidine-tagged proteins, the batch elution step is replaced by gradient elution with an increasing imidazole concentration (0 to 1 M). Reductive methylation of the amino groups of surface lysine residues is performed as described by Rayment, I. (1997). Methods Enzymol. 276, 171-179.

3.b.(iii). Robotic Crystal Diffraction-Quality Screening

Harvestable crystals (dimensions greater than 50 mm) are mounted, flash-frozen and screened for diffraction quality in-house using a Rigaku/MSC ACTOR robot (http://www.rigakumsc.com). Diffraction-quality crystals are then recovered and stored at cryogenic temperatures awaiting data collection. All information from the diffraction screening, including crystal size, unit cell, space group, resolution, mosaicity and storage location is recorded in the XtalDB database (a web-enabled system developed at SECSG) for process control and future reference.

3.b.(iv) Data Collection and Data Processing

Data is currently collected at beamlines administered by the Southeast Regional Collaborative Access Team (SER-CAT, Sector 22, Advanced Photon Source, Argonne National Laboratory). Additionally, data can be collected in-house on CCD (Bruker SMART 6000 and Rigaku Saturn92) detectors using a copper rotating-anode source (Rigaku FR-D X-ray generator) or on an Rigaku R-AXIS IV image-plate detectors using a chromium rotating anode and associated confocal optics. Standard phasing protocols include sulfur/metal SAS phasing from native crystals, Xe SAS phasing, iodine SAS phasing using quick soaks and Se-Met SAS/MAD phasing. A promising phasing technique uses Cr Kα radiation and native crystals. Data reduction is carried out using either the d*TREK (Rigaku/MSC) or HKL2000 suites.

3.b.(v). High-Throughput Crystal Structure Determination Pipelines

Characterization of the heavy-atom or anomalous scattering substructure for SAS, MAD, SIRAS and MIRAS experiments is carried out using SOLVE (See, Terwilliger, T. C. & Berendzen, J. (1999). Acta Cryst. D55, 849-861) or SHELXD (See, Schneider, T. R. & Sheldrick, G. M. (2002). Acta Cryst. D58, 1772-1779). Initial phasing is carried out using either the SOLVE or ISAS (See, Wang, B.-C. (1985). Methods Enzymol. 115, 90-112.) packages. Phase improvement utilizes the programs RESOLVE (See, Terwilliger, T. C. & Berendzen, J. (1999). Acta Cryst. D55, 849-861) and DM (See, Cowtan, K. & Main, P. (1998). Acta Cryst. D54, 487-493.). For molecular replacement calculations, the programs AMoRe (See, Navaza, J. (2001). Acta Cryst. D57, 1367-1372.), EPMR (See, Kissinger, C. R., Gehlhaar, D. K. & Fogel, D. B. (1999). Acta Cryst. D55, 484-491), PHASER (See, Storoni, L. C., McCoy, A. .J. & Read, R. J. (2004). Acta Cryst. D60, 432-438) or scripts from CNS (See, Brunger, A. T., Adams, P. D., Clore, G. M., DeLano, W. L., Gros, P., Grosse-Kunstleve, R. W., Jiang, J.-S., Kuszewski, J., Nilges, M., Pannu, N. S., Read, R. J., Rice, L. M., Simonson, T. & Warren, G. L. (1998). Acta Cryst. D54, 905-921) suite are used. The programs SOLVE, RESOLVE, ISAS and AMoRe have been integrated into HT pipelines running on a multi-node computer cluster.

3.b.(vi). Structure-Refinement and Validation Pipeline

Automated model (re-)building is carried out with the programs RESOLVE (See, Terwilliger, T. C. & Berendzen, J. (1999). Acta Cryst. D55, 849-861.) and ARP/wARP (See, Perrakis, A., Morris, R. & Lamzin, V. S. (1999). Nature Struct. Biol. 6, 458-463) in an iterative manner with maximum-likelihood positional and thermal parameter refinement by REFMAC (See, Murshudov, G. N., Vagin, A. A. & Dodson, E. J. (1997). Acta Cryst. D53, 240-255). Models are examined for errors based on their correlation with experimental data (SFCHECK; See, Vaguine, A. A., Richelle, J. & Wodak, S. J. (1999). Acta Cryst. D55, 191-205), main-chain andside-chain torsion angles and atom clashes after addition of H atoms (MOLPROBITY; See, Davis, I. W., Murray, L. W., Richardson, J. S. & Richardson, D. C. (2004). Nucleic Acids Res. 32, W615-W619). Manual rebuilding, when necessary, with XFIT (See, McRee, D. E. (1999). J. Struct. Biol. 125, 156-165.) is iterated with REFMAC and further validation. For submission to the PDB, the program PDB_EXTRACT is used.

3.c. Results and Discussion

3.c.(i). Crystallization

The crystallization facility used was developed to handle ten new protein samples/constructs per 8 h day, aimed at analyzing 2000 or more proteins/constructs annually consistent with PSI-2 goals.

Incoming samples from the protein production and crystallomics cores are assigned an independent data matrix two-dimensional barcode and the physical characteristics of the sample (buffer, concentration, modifications etc.) and storage location are recorded in a sample-tracking database, SampleDB. All barcodes are printed using a high-resolution barcode printer. Any alteration of the initial sample (e.g. protein concentration change due to dilution) results in the assignment of a new barcode and database entry. Aliquots of the same protein sample can therefore be tracked independently in the crystallization records.

Incoming proteins are screened against seven commercially available screens and an developed MP1 screen, giving a total of 384 crystallization screening experiments using a total of less than 80 ml protein solution.

Crystal trays are barcoded (hexadecimal six character linear barcode) and logged into the crystallization database together with details of the protein sample and the screening matrix used. Currently, all crystallization experiments, once set up, are loaded into the CrystalFarm integrated imaging/incubator unit. The plate barcodes are read, imaging is scheduled and images and scoring results stored in the CrystalFarm database. Currently, drops are photographed once a week for four weeks. When crystals of sufficient size are found, they are harvested (see below). If further optimization is needed, the solutions of optimization screens are mixed and dispensed into a 96-well 1.5 ml deep block tray or 96-well tray using a Tecan liquid-handling robot. Optimization screens consist of a single (36-well) or double (72-well) grid screen based on variations of buffer pH, precipitant and salt concentrations. Optimization trays are stored and imaged using the CrystalFarm as described above. Further optimization using the Hampton Research Additive Screens 1 and 2 is carried out in cases where initial optimization fails to produce diffraction-quality crystals. Finally, if the additive screen still fails to produce diffraction-quality crystals, the protein target is diverted to the target-salvaging pathway (see Section 3.b.(ii).

FIG. 15 provides a flow diagram illustrating operation of the high-throughput pipeline from protein expression to crystallization. Tier 1 is the mainstream production unit and the major tasks are diagramed in circles. Tier 2 shows the salvaging pathways and the salvaging components are outlined in squares. In this example, a total of 50 targeted proteins were run through the salvaging pathways and consequently structures were obtained where they would not have been acquired otherwise.

3.c.(ii). Crystallomics and Target Salvaging

Using the purification and sample-modification techniques described previously, seven structures were produced from a set of 50 P. furiosus proteins that either failed to crystallize or gave poor diffracting crystals. The following examples illustrate the potential of the present methods as a target-salvaging pathway. Conserved hypothetical protein PF0863 (Pfu-838710) gave only marginally diffracting crystals from the initial sample. Polyacrylamide gel electrophoresis (PAGE, overloaded gels) of the initial sample showed that it contained a number of minor but significant bands. Upon re-purification, crystals diffracting to 2.3 Å resolution were obtained. The structure was solved and a model is currently undergoing refinement. Conserved hypothetical protein PF0380 (Pfu-392566) failed to give crystals from the initial sample. Upon re-purification, the sample produced crystals that were too small for X-ray analysis. Reductive methylation of the re-purified protein however gave crystals that diffracted to 1.2 Å resolution and the structure was solved. A refined model was deposited in the PDB (code 1vk1).

3.c.(iii). Robotic Crystal Diffraction-Quality Screening

Crystal classification according to diffraction quality is handled by the Rigaku ACTOR/Director system that mounts flash-frozen crystals (See, Hope, H. (1988). Acta Cryst. B44, 22-26 and Teng, T.-Y. (1990). J. Appl. Cryst. 23, 387-391) from an LN₂ dewar onto the goniometer and automatically centers the crystal, collects images, indexes the crystal and if desired collects data unattended. Within 18 h, divided into two daily shifts, the unit cell, Laue group and diffraction limits of more than 100 crystals can be determined. Automation of this tedious procedure relieves personnel and reduces the probability of missing well diffracting specimens among a large number of poorly diffracting crystals. Based on the diffraction information, available beam time on the home or synchrotron sources can be prioritized.

3.c.(iv). Data Collection and Data Processing

Several X-ray sources with different characteristics are useful for a range of data-collection problems. Beamlines providing tunable, intense and brilliant X-rays are useful for phasing and high-resolution experiments. Several structures were solved during the commissioning stages of both SER-CAT beamlines. The University of Georgia share in SER-CAT (Sector 22) provides approximately 24 h beam time per month of operation on its both 22ID insertion-device beamline and 22BM bending-magnet beamline once it is fully commissioned. The SER-CAT beamlines are equipped with state-of-the-art MAR Research (http://www.marusa.com) 300 mm (22ID) and 225 mm (22BM) CCD detectors. A dual-port chromium rotating anode at the University of Georgia is equipped with large R-AXIS IV image-plate detectors, chromium confocal optics and helium beam paths. Its soft X-rays (λ=2.29 Å) are suitable for the exploitation of weak anomalous scatterers such as sulfur in the phasing of protein structures. The structure determination of the hyperthermophile protein Sso10a (Chen et al., 2004) is an example of the application of this. A dual port ultrahigh-intensity copper rotating anode equipped with confocal optics and CCD detectors at the University of Georgia is also useful for data collection and crystal characterization (see Section 3.c.(iii)).

3.c.(v). High-Throughput Crystal Structure-Determination Pipelines

Pipelines for de novo and molecular-replacement structure solution are implemented on a Linux-based multi-node computer cluster (provided by an IBM SUR Award). The combination of software pipelines and a high-throughput computing environment permits the easy setup of hundreds of jobs. Thus, for a given set of data, multiple SAS, MAD or molecular-replacement computations can be set up each using a slightly different set of program input parameters. For example, computations can be carried out using different data resolution ranges simply by defining the minimum and maximum resolution to be screened and the size of the resolution step used to cover the desired range. The pipeline workflow manager then uses this information to generate the appropriate program inputs for N jobs that are required to satisfy the request. This approach has been applied with success in more than 30 cases. For example, P. furiosus DNA-directed RNA polymerase subunit ε″ crystallizes in a trigonal space group, which could only be determined from the successful structure determination. The pipeline was used to carry out computations in all candidate space groups and the correct solution identified. A model of this protein refined at 1.38 Å resolution has been deposited in the PDB with code 1ryq. The AMoRe pipeline allows easy screening of resolution limits for the rotation and translation searches as well as radius used for intramolecular Patterson peaks and has produced solutions in cases where the search model exhibited less than 30% sequence identity (for example P. furiosus NADH oxidase/nitrite reductase).

3.d. Structure-Refinement and Validation Pipeline

While always striving to increase the throughput of the protein-to-structure pipeline, the present methods also aims at producing structural models of the highest quality. Procedures for the combination of newly developed structure-validation tools with refinement programs in use for all stages of refinement have been evaluated and have become part of standard procedures. Our current approach uses (i) updated versions of the standard Ramachandran side-chain rotamer database and bond-angle criteria (See, Lovell, S. C., Davis, I. W., Arendall, W. B. III, de Bakker, P. I., Word, J. M., Prisant, M. G., Richardson, J. S. & Richardson, D. C. (2003). Proteins, 50, 437-450 and Lovell, S. C., Word, J. M., Richardson, J. S. & Richardson, D. C. (2000). Proteins, 40, 389-408.), (ii) crystallographic R, Rfree (See, Brunger, A. T. (1992). Nature (London), 355, 472-475) and difference map peaks, (iii) hydrogen-bonding and analysis of side-chain amide and imidazole orientation (See, Word, J. M., Lovell, S. C., Richardson, J. S. & Richardson, D. C. (1999). J. Mol. Biol. 285, 1735-1747) and (iv) H atom addition and all-atom steric clashes (See, Richardson, J. S., Arendall, W. B. III & Richardson, D. C. (2003). Methods Enzymol. 374, 385412. and ; Word, J. M., Lovell, S. C., Richardson, J. S. & Richardson, D. C. (1999). J. Mol. Biol. 285, 1735-1747). All recent structure submissions from the University of Georgia's SECSG crystallography core have undergone the automatic correction of Asn/Gln/His flips available in REDUCE or online at the MOLPROBITY site (http://kinemaqe.biochem.duke.edu) and MOLPROBITY's rotamer, Ramachandran and clash information has been incorporated early on in the refinement process. As the procedures became more integrated, the final structures improved in all criteria. Structural models are deposited into the Protein Data Bank utilizing the PDB_EXTRACT tool (See, Yang, H., Guranovic, V., Dutta, S., Feng, Z., Berman, H. M. & Westbrook, J. D. (2004). Acta Cryst. D60, 1833-1839). For this purpose, relevant program output for diffraction data reduction, phasing and refinement is stored in a centralized location, ensuring that at the time of deposition, all information pertaining to a given model is easily accessible for the extraction of relevant data items.

TABLE 6
Accumulated summary of protein structure determination

| Protein | Purified | Crystallized | X-ray data | Structure |
|---|---|---|---|---|
| P. furiosus | 201 | 1.02 | 53 | 22 |
| C. elegans | 196 | 73 | 20 | 14 |
| Human | 41 | 5 | 4 | 3 |
| Total | 438 | 180 | 77 | 39 |

3.e. Conclusions

We have developed a high-throughput protein-to-structure pipeline using a variety of robots and automation procedures. This pipeline is composed of three relatively independent yet closely connected activities: crystallization, crystallomics and structure determination/validation. Communications between the modules are supported by several relational databases. After implementation and testing of the pipeline, we find that the use of the robots and automation is useful to high-throughput operations. Additionally, since a large amount of experimental data must be archived, analyzed and shared among the various pipeline components the appropriate implementation of a data-management system is important to the success of the pipeline.

The execution of the salvage pathways can begin at three different levels during high-throughput operations. The earliest can take place at the gene level where new recombinant constructs are made to increase expression or solubility. The second is at the protein purification and preparation level. Finally, the third is to optimize conditions for proteins that crystallize but do not diffract. These applications constitute the tier 2 pathways designed to couple those of tier 1. The overall approach is schematized in FIG. 15. This example focuses on the latter two salvaging pathways. The ‘target salvaging’ effort is an important component of the pipeline. With comparatively little additional effort, many valuable ‘failed’ target proteins can eventually yield structures.

Target salvaging increases the cost-effectiveness of the structural genomics operations by reducing the number of targets that are abandoned after considerable initial efforts in the upstream stages. The target-salvaging effort is carried out by the crystallomics core. In tier 1, the protein production core is focused on producing target proteins in rapid pace. The purified proteins go through the crystallization unit and the proteins that fail to produce useful crystals for structure determination enter tier 2 or ‘target salvaging’. In addition to the preparation of samples with increased purity and homogeneity, the crystallomics core introduces chemical modifications to the proteins (such as tag removal, methylation, surface mutagenesis, selenomethionine labeling) as required. The high-throughput operation in structural genomics is not a simple scale-up of a traditional crystallographic laboratory; it requires additional resources for planning, testing, fine-tuning and project management. Success in high throughput and automation relies on the harmonious integration of hardware and software at each stage and a seamless transition and effective bi-directional communication mechanisms between the various stages.

We claim:

1. A method for determining the structure of a crystal, said method comprising the steps of:
providing an X-ray diffraction data set for said crystal and a set of input parameters; wherein said set of input parameters includes one or more variable input parameters and one or more fixed input parameters; wherein each of said variable input parameters have a plurality of screened values and wherein each of said fixed input parameters have a fixed value;
determining all possible combinations of said screened values corresponding to each of said variable input parameters and said fixed values, wherein each of said combinations comprises all of said fixed values and one screened value for each variable input parameter;
calculating putative crystal structures corresponding to each of said combinations;
assessing the confidence of each of said putative crystal structures, wherein a confidence assessment is assigned to each of said putative crystal structures; and
selecting the putative crystal structure having the highest confidence assessment, thereby determining the structure of said crystal.

2. The method of claim 1 wherein said putative crystal structures are calculated in parallel.

3. The method of claim 1 wherein said step of determining all possible combinations of said screened values corresponding to each of said variable input parameters and said fixed values is performed by a pipeline interface.

4. The method of claim 1 wherein said step of determining all possible combinations of said screened values corresponding to each of said variable input parameters and said fixed values is performed by a work flow manager.

5. The method of claim 1 wherein said step of providing said X-ray diffraction data set for said crystal and said set of input parameters is performed by a pipeline interface.

6. The method of claim 5 wherein said pipeline interface is a dictionary-driven pipeline interface.

7. The method of claim 5 wherein step of calculating putative crystal structures corresponding to each of said combinations is carried out using a work flow manager.

8. The method of claim 7 wherein said pipeline interface and said work flow manager are in operational communication.

9. The method of claim 7 wherein said pipeline interface generates a control file corresponding to said X-ray diffraction data, said variable input parameters and said fixed input parameters and wherein said control file is received as input to said work flow manager.

10. The method of claim 7 wherein said work flow manager constructs a plurality of computational pipelines for calculating said putative crystal structures in parallel.

11. The method of claim 10 wherein said computational pipeline is a modular computational pipeline comprising a plurality of integrated crystallographic and bioinformatic analysis modules.

12. The method of claim 11 wherein said analysis modules are defined in a program library in operational communication with said work flow manager.

13. The method of claim 12 wherein said analysis modules are selected from the group consisting of:
a single wavelength anomalous scattering analysis module;
a multiple wavelength anomalous scattering analysis module;
a molecular replacement analysis module;
a multiple isomorphous replacement analysis module;
a single Isomorphous replacement analysis module;
a sequence comparison module;
a reference structure alignment module;
a format converting module;
a biological database access module; and
an annotation module.

14. The method of claim 10 wherein said computational pipeline calculates putative crystal structures corresponding to each of said combinations.

15. The method of claim 1 wherein said variable input parameters are selected from the group consisting of:
the minimum resolution of said X-ray diffraction data set;
the maximum resolution of said X-ray diffraction data set;
the number of heavy atom scatterers in a unit cell of said crystal;
the solvent content of said crystal;
the number of molecules in an asymmetric unit of said crystal;
the F″ of the data; and
the symmetry space group of the crystal.

16. The method of claim 1 wherein said input parameters further comprises supplementary data selected from the group consisting of:
a peptide sequence corresponding to said crystal;
the composition of said crystal;
a nucleic acid sequence corresponding to said crystal;
the wavelength of said X-ray beams; and
crystal orientations corresponding to said X-ray diffraction data set.

17. The method of claim 1 wherein said step of assessing the confidence of each of said putative crystal structures is performed by an output parser.

18. The method of claim 1 wherein said crystal comprises a material selected from the group consisting of:
proteins;
peptides;
oligonucleotides;
protein-protein complexes;
protein-peptide complexes;
protein-cofactor complexes;
peptide-peptide complexes;
carbohydrates;
nucleic acid—protein complexes; and
lipid—carbohydrate complexes.

19. The method of claim 1 wherein said putative crystal structures are calculated using a method selected from the group consisting of:
a single-wavelength anomalous diffraction method;
a multiple-wavelength anomalous diffraction method;
a molecular replacement method;
a single isomorphous replacement method; and
a multiple isomorphous replacement method.

20. The method of claim 1 comprising a fully automated method or a partially automated method.

21. A method for determining the structure of a crystal, said method comprising the steps of:
providing an X-ray diffraction data set for said crystal and a set of input parameters as input to a pipeline interface; wherein said set of input parameters includes one or more variable input parameters and one or more fixed input parameters; wherein each of said variable input parameters have a plurality of screened values and wherein each of said fixed input parameters have a fixed value;
generating as output of said pipeline interface a control file comprising said X-ray diffraction data and said input parameters;
determining all possible combinations of said screened values corresponding to each of said variable input parameters and said fixed values, wherein each of said combinations comprises all of said fixed values and one screened value for each variable input parameter;
transmitting said control file to a work flow manager, wherein said work flow manager generates a computational pipeline for calculating said structure of said crystal;
calculating putative crystal structures corresponding to each of said combinations using said computational pipeline;
assessing the confidence of each of said putative crystal structures, wherein a confidence assessment is assigned to each of said putative crystal structures; and
selecting the putative crystal structure having the highest confidence assessment, thereby determining the structure of said crystal.

22. A method for determining the electron density distribution of a crystal, said method comprising the steps of:
providing an X-ray diffraction data set for said crystal and a set of input parameters; wherein said set of input parameters includes one or more variable input parameters and one or more fixed input parameters; wherein each of said variable input parameters have a plurality of screened values and wherein each of said fixed input parameters have a fixed value;
determining all possible combinations of said screened values corresponding to each of said variable input parameters and said fixed values, wherein each of said combinations comprises all of said fixed values and one screened value for each variable input parameter;
calculating putative electron density distributions corresponding to each of said combinations;
assessing the confidence of each of said putative electron density distributions, wherein a confidence assessment is assigned to each of said putative electron density distribution; and
selecting the putative electron density distribution having the highest confidence assessment, thereby determining the electron density distribution of said crystal.
